(19) United States
(12) Patent Application Publication
(10) Pub. No.: US 2026/0339933 A1
(43) Pub. Date: Oct. 29, 2026

(54) GENERATIVE LANGUAGE MODEL SYSTEM WITH EMPATHY-TUNED EXPERT ADAPTER

(71) Applicant: Microsoft Technology Licensing, LLC, Redmond, WA (US)

(72) Inventors: Jin A SUH, Seattle, WA (US); Javier HERNANDEZ RIVERA, Somerville, MA (US); Nagendran RANGAN, Redmond, WA (US); Seyed Erfan SHAYEGANI, Riverside, CA (US); Andrew David WILSON, Seattle, WA (US)

(73) Assignee: Microsoft Technology Licensing, LLC, Redmond, WA (US)

(21) Appl. No.: 19/253,440

(22) Filed: Jun. 27, 2025

Related U.S. Application Data
(60) Provisional application No. 63/794,971, filed on Apr. 25, 2025.

(51) Int. Cl. G06F 16/245; G06F 18/23

(52) U.S. Cl. CPC G06F 16/245; G06F 18/23

(57) ABSTRACT

A computing system is provided, including processing circuitry configured to, in a training phase, receive a plurality of example multi-turn conversations between users and generative language models involving tasks, where each task has associated levels and/or types of empathy. The processing circuitry is further configured to generate synthetic multi-turn conversations for each task cluster based on empathy patterns, using a generative language model system, and train an expert adapter based on the synthetic multi-turn conversations to adapt an output of the generative language model system to achieve a task-specific target level and/or type of empathy. In an inference phase, the processing circuitry is further configured to receive an inference-time user query related to an inference-time task at the generative language model system, which includes a generative language model and the trained expert adapter, and generate a response to the inference-time user query using the generative language model and expert adapter.

### CROSS REFERENCE TO RELATED APPLICATIONS

The present application is based upon and claims priority under 35 U.S.C. 119(e) to U.S. Provisional Patent Application No. 63/794,971, entitled FROM MEASUREMENT TO EXPERTISE: TRAINING CONTEXTUALLY EMPATHETIC EXPERT ADAPTERS, filed Apr. 25, 2025, the entirety of which is hereby incorporated herein by reference for all purposes.

### BACKGROUND

Generative language models such as large language models (LLMs) have been developed that can receive a natural language user query and in response generate a natural language response at an appropriate level of detail, with references to grounded sources used to gather the information contained in the response. While increasingly useful for factual inquiries, generative language models can sometimes fail to meet users' expectations regarding the tone of the model responses. One such tonal characteristic is empathy. A generative language model that fails to generate a response that is perceived as appropriately empathetic by a user, can miss opportunities for creating meaningful and satisfying user interactions or even offend the user, particularly when dealing with sensitive or personal topics.

### SUMMARY

To address these issues, a computing system is provided herein. In one example, the computing system includes processing circuitry and memory storing instructions that, during execution, cause the processing circuitry to, in a training phase, receive a plurality of example multi-turn conversations between users and generative language models involving tasks, each task having associated levels and/or types of empathy. During the training phase, the processing circuitry is further configured to cluster the tasks based on empathy levels and/or types associated with each task to identify shared empathy task clusters and determine empathy patterns for each task. The processing circuitry is further configured to generate synthetic multi-turn conversations for each task cluster based on the empathy patterns, using a generative language model system. The processing circuitry is further configured to train an expert adapter based on the synthetic multi-turn conversations to adapt an output of the generative language model system to achieve a task-specific target level and/or type of empathy. In an inference phase, the processing circuitry is configured to receive an inference-time user query related to an inference-time task at the generative language model system, which includes a generative language model and the trained expert adapter. The processing circuitry is further configured to generate a response to the inference-time user query using the generative language model and expert adapter of the generative language model system, the response being generated to exhibit a level and/or type of empathy specific to the inference-time task in the inference-time user query.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computing system according to one example of the present disclosure.

FIG. 2 illustrates a system prompt used to ensure multi-turn coherency, used by the computing system of FIG. 1.

FIG. 3 illustrates the predictions of the trained preference model, wherein β sets the sensitivity and the sharpness of the preference model, in the computing system of FIG. 1.

FIG. 4 presents the predictions of the generic reward model, in the computing system of FIG. 1.

FIG. 5 illustrates a comparison of empathy levels across different tasks, illustrating the effectiveness of context-specific expert adapters in aligning with pre-desired empathy levels.

FIG. 6 illustrates a comparison of empathy retention across different settings: Expert Adapter, System Prompt, and Baseline.

FIG. 7 illustrates that average perceived empathy highly correlates with user satisfaction signals more than any of the distinct empathy dimensions.

FIG. 8A illustrates that, within each task, conversations are distributed across four models: GPT-4-32k, GPT-3.5-32k, LLAMA-70B, and GPT-4-32k-Empathy.

FIG. 8B illustrates GPT-4 being prompted as a judge, tasked with classifying AI assistant messages in conversations as either empathetic or non-empathetic.

FIG. 9 shows prompt template used for the LLM judge for the experiment in FIG. 8B.

FIGS. 10A and 10B show a prompt template used in the multi-turn conversation generation pipeline with GPT-4o to generate the initial user questions for the “Distressing/Social/Personal Situations” task cluster.

FIG. 11 shows initial user questions generated by GPT-4o with the prompt in FIGS. 10A and 10B for the “Distressing/Social/Personal Situations” task cluster.

FIG. 12 shows correlation between the gap in post-perceived and pre-desired empathy levels with post-task experience signals.

FIGS. 13A and 13B present the empathetic steering prompts used for two task clusters: “Distressing/Social/Personal Situations” (FIG. 13A) and “Learning Skills” (FIG. 13B).

FIGS. 14A and 14B present the non-empathetic steering prompts designed for two task clusters: “Distressing/Social/Personal Situations” (FIG. 14A, left) and “Learning Skills” (FIG. 14B, right).

FIG. 15 shows the prompt used to instruct GPT-4o to steer the assistant responses toward the defined empathy patterns per task cluster.

FIG. 16 shows prompt template used for the reward model based on the LLM-as-a-judge.

FIG. 17 shows Algorithm 1 which outlines the details of the synthetic multi-turn conversation generation pipeline.

FIG. 18 shows Table I including parameters reward model training.

FIG. 19 shows Table II including generic reward model evaluation.

FIG. 20 shows Table III including parameters for preference model (BT) training.

FIG. 21 shows Table IV including parameters for supervised fine-tuning.

FIG. 22 presents Table V including results related to multi-turn empathy robustness.

FIG. 23 shows Table VI including evaluation results for different models and settings.

FIG. 24 shows Table VII including failure cases during user turn generation.

FIG. 25 shows Table VIII including the most common user comments in real dataset.

FIG. 26 shows Table IX including regression analysis of empathy averaged over carious prompt engineering settings.

FIG. 27 shows Table X including different prompt engineering settings comparing regression analysis of LLM-based reward models.

FIG. 28 shows a flowchart of a computerized method according to one example implementation of the computing system of FIG. 1.

FIG. 29 shows a schematic view of an example computing environment in which the computing system of FIG. 1 or other figures may be enacted.

### DETAILED DESCRIPTION

Existing generative language models often generate responses that exhibit a uniform level of empathy regardless of a user's emotional state or the conversation's context. This uniformity leads to unsatisfactory user experiences, especially in scenarios where the appropriate level of empathy varies significantly. For instance, the empathy that is appropriate when offering emotional support during a distressing life event is different than when providing guidance for professional development. The inability to generate responses with appropriate empathy hinders the potential effectiveness of artificial intelligence (AI) assistants in applications like mental health support, customer service, and personalized coaching, where adaptability in empathetic expression is crucial. Thus, a technical challenge exists in configuring a generative language model that can generate responses that exhibit contextually appropriate empathy.

To address the issues discussed above, a computing system with a framework that can enhance the context-sensitive empathetic capabilities of large language models through the integration of expert adapters and synthetic data augmentation is disclosed herein. The implementation begins with analyzing real-world conversational datasets containing users' desired empathy levels, perceived empathy ratings, and qualitative feedback. These insights inform the design of empathy measurement methods and reward models that refine the LLM's responses. Specifically, a real-world conversational dataset consisting of 755 multi-turn conversations across 8 tasks was generated, and revealed significant differences in terms of expected and experienced empathy before and after the conversations, respectively. To address data scarcity in this dataset and produce a diverse and contextually rich training dataset, a synthetic multi-turn conversation generation pipeline was developed. As explained below, the synthetic multi-turn conversational generation pipeline steers responses toward the defined empathy patterns based on the context, in order to generate a response that is more likely to more closely match a user's expectations.

In the present implementation, a plurality of expert adapters for context-specific empathy were trained based on the synthetically generated conversations, specializing in varying empathy levels of the generative language model based on a recognized task. By using these expert adaptors, empirical results demonstrated a significant gap reduction of 72.66% between perceived and desired empathy compared to not using the expert adaptors, with scores increasing by an average factor of 2.43 when the expert adapters were deployed, as measured by the metrics and reward models of the present disclosure. Additionally, trained expert adapters demonstrate superior effectiveness in preserving empathy patterns throughout conversation turns, outperforming system prompts, which tend to dramatically diminish in impact as conversations lengthen. The present approach offers technical advantages such as improved adaptability and generalizability of AI agents, sustained empathy in extended dialogues, and enhanced user satisfaction.

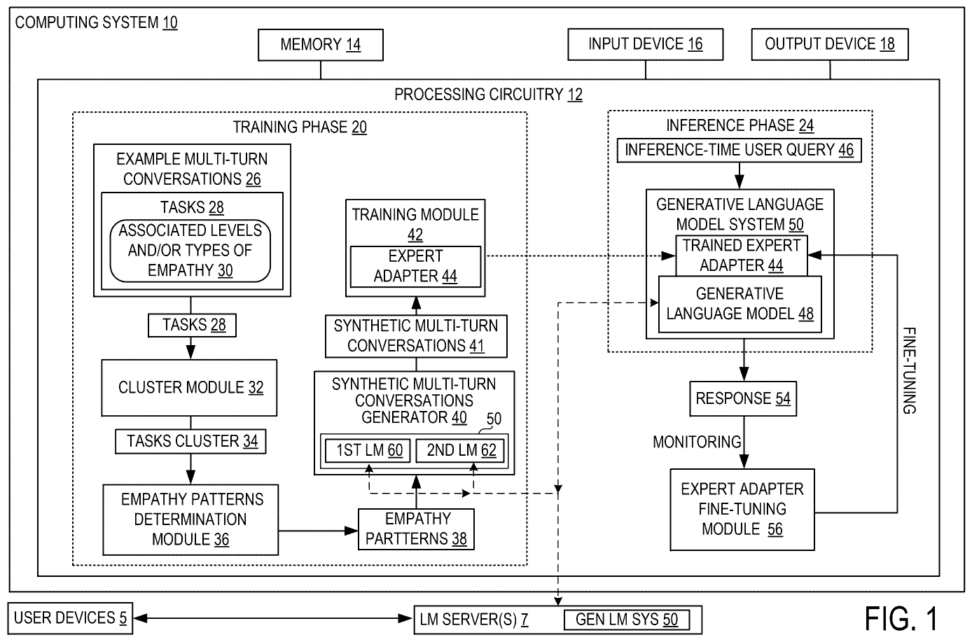

Turning now to FIG. 1, a computing system 10 is provided to address the issues identified above. The computing system 10 comprises processing circuitry 12, memory 14, one or more input devices 16 for receiving user input, and one or more output devices 18 such as a display. Although one computing device with processing circuitry 12 is illustrated in computing system 10, it will be appreciated that computing system 10 may be implemented across one or more devices. For example, training and inference may be implemented by different devices. The processing circuitry 12 and memory 14 therefore can be comprised of processing circuitries and memories of different computing devices. Further, in both the training and inference phases, computing system 10 may include multiple computing device that act in concert to perform the functions described herein. Where references are made to machine learning models such as generative language models, it will be appreciated that these models may be hosted locally at computing system 10, or on remote devices and called by agents executed at computing system 10, such as the language model server(s) 7.

The memory 14 stores instructions that, during execution, cause the processing circuitry 12 to, in a training phase 20, receive a plurality of example multi-turn conversations 26 between users and generative language models involving tasks 28. The example multi-turn conversations 26 can originate as conversations between users using user devices 5 and generative language models of generative language model system 50 executed on language model server 7, as shown.

Each task 28 has associated levels and/or types of empathy 30. The associated levels and/or types of empathy 30 of the example multi-turn conversations 26 include (1) user-expected empathy level and/or tone in the output of the generative language model system 50 in each conversation about each associated task, and/or (2) user-perceived actual empathy level and/or tone in the output generated by the generative language model system 50 in each conversation about each associated task.

The processing circuitry 12 is configured to cluster, via a cluster module 32, the tasks 28 based on empathy levels and/or types associated with each task 28 to identify shared empathy task clusters 34. The processing circuitry 12 is further configured to determine, via empathy patterns determination module 36, empathy patterns 38 for each task cluster 34.

In the training phase 20 described above, a real-world conversational dataset can be used as the example multi-turn conversations 26. In one example implementation of the training phase 20, a dataset was used that included 755 multi-turn interactions between users and AI assistants across eight distinct tasks conducted with participants interacting naturally with the chatbots who reported their desired and perceived level of empathy before and after each conversation, respectively. In particular, participants reported perceived empathy along multiple dimensions such as Affective, Cognitive, and Contextual. The eight tasks included navigating work issues, career/self-improvement challenges, overcoming personal issues, writing assistance, thinking through a work assignment, learning new skills, handling distressing situations, and navigating social situations. Participants also responded to several 5-point Likert scale questions focused on assessing the level in which the AI assistant achieved success, the level of user engagement, the positivity of the interaction, and likelihood of future use among others. In addition, participants also provided qualitative feedback on their experience.

The dataset in this example included 151 participants, with 109 completing at least five conversations and an exit survey, resulting in 755 fully labeled conversations. Among the participants, 55 identified as men and 54 as women, with the majority aged between 26-35 years (30.3%), followed by 46-55 years (28.4%) and 36-45 years (22%). Most participants held a bachelor's degree (42.2%) or a master's degree (39.4%), and 71.3% report English as their first language. Occupations primarily included software development and engineering (38.5%), business and finance (24.8%), and project management (17.4%), among others. Participants interacted with four different AI agents to evaluate perceived empathy: GPT-4, GPT-4 with an empathy-enhanced system prompt (GPT-4-Empathy), Llama2-Chat-70B, and a GPT-3.5-Turbo. Each agent was designed to explore how varying architectures and settings influenced empathic interactions. The dataset yielded two primary findings:

(1) Average perceived empathy highly correlates with self-reported satisfaction after the conversation (Pearson's Correlation=0.64).

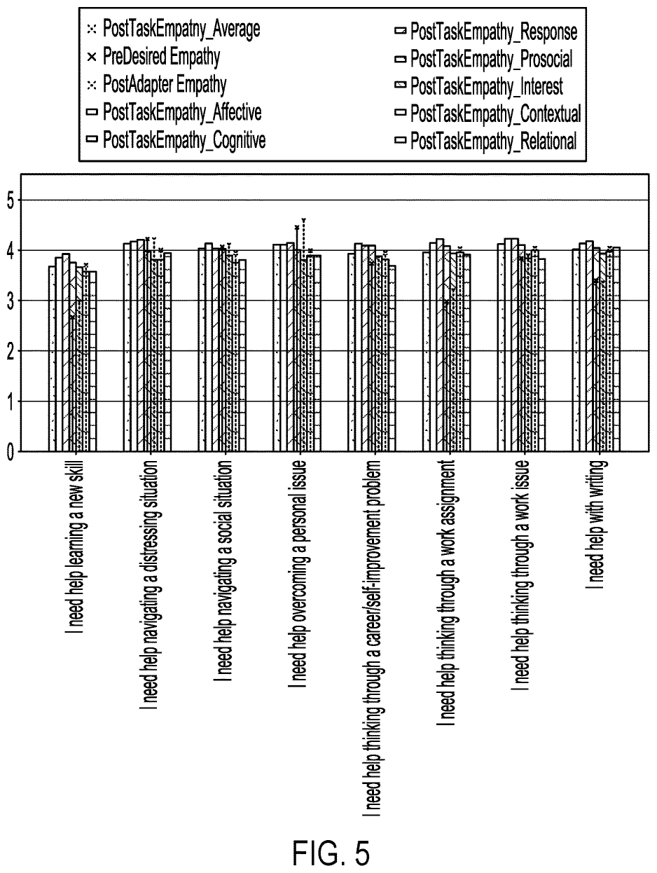

(2) Desired empathy varies significantly depending on the task and context. For example, as shown by the pre-desired empathy bars in FIG. 5, tasks around overcoming personal issues and distressing situations require much more empathy compared to tasks on learning new skills or thinking through work assignments.

FIG. 5 shows various dimensions of perceived empathy as well as the pre-desired empathy recorded by the users per task, in this example training dataset.

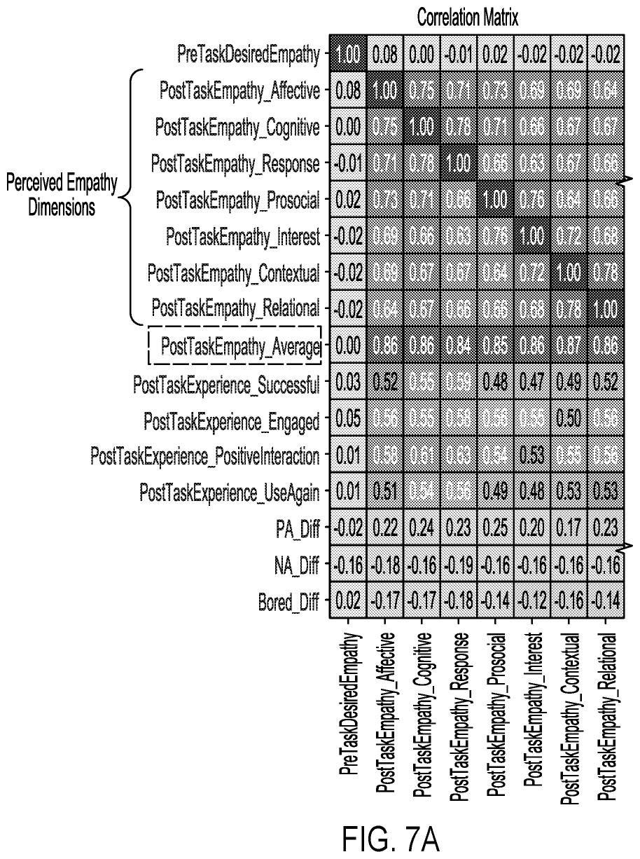

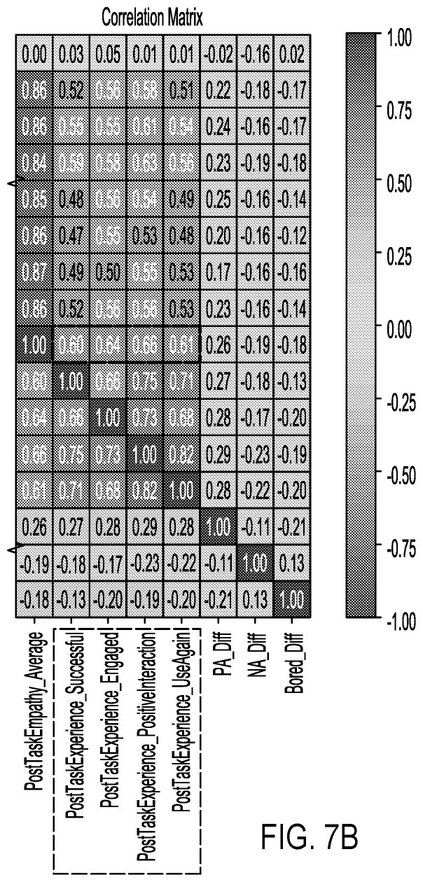

FIG. 7 refers to the correlations between the user satisfaction metric and the average perceived empathy, in this example training dataset.

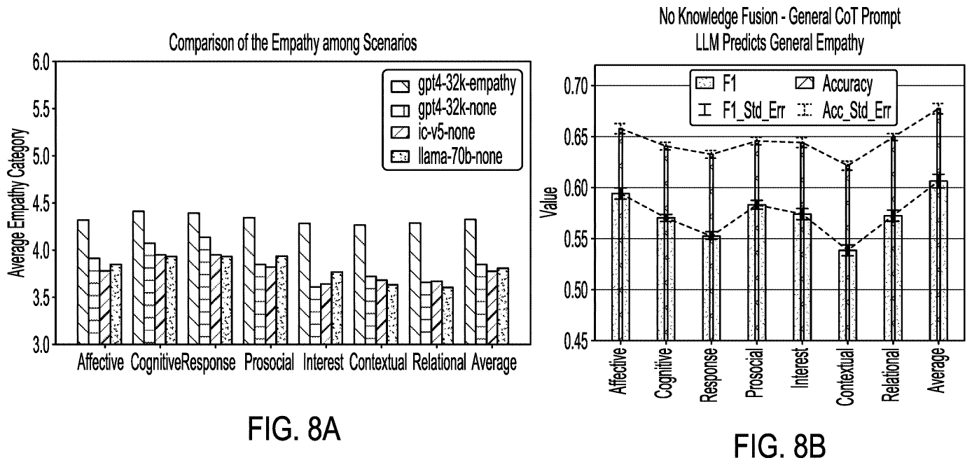

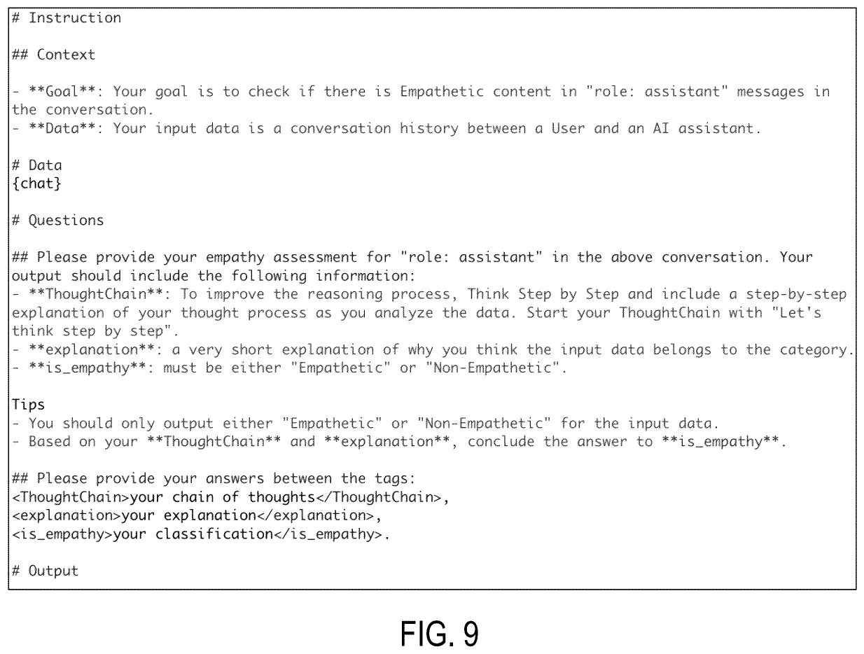

FIGS. 8A and 8B give insights into the different models' levels of empathy among the various dimensions of empathy and shows that all the models have almost the same notion of empathy despite their different training procedures including the data, architecture, and scale. It also shows that the LLMs' inherent knowledge of empathy is a general understanding of all the dimensions averaged rather than a detailed grasp of its specific dimensions. FIG. 8A illustrates that, within each task, conversations are distributed across four models: GPT-4-32k, GPT-3.5-32k, LLAMA-70B, and GPT-4-32k-Empathy. The last model, GPT4-32k-empathy, is a variant with a system prompt specifically designed to enhance empathetic responses. This figure with different models suggests that their knowledge of empathy is similar and they all have almost the same notion of empathy despite their different training procedures including the data, architecture, and scale. FIG. 8B shows GPT4 prompted as a judge (see FIG. 9) responsible for classifying the AI assistant messages in the conversations as empathetic or non-empathetic and then compare the predictions with the labels from the dataset for each dimension of empathy. The highest accuracy and F1 scores for average empathy suggest that LLMs possess a general understanding of empathy, rather than a detailed grasp of its specific dimensions.

FIG. 9 shows the prompt used for the LLM judge experiment for the FIGS. 8A and 8B results. The conversation history is loaded into the {chat} variable in the prompt template. However, it will be appreciated that the example real world conversations may be limited in scope and number, and thus may suffer from data scarcity. Training directly on such a dataset thus may result in overfitting or bias in the model to a small number of examples, which may decrease the ability of the model to properly identify general patterns and apply those learnings at inference time.

Returning to FIG. 1, to address these issues with potential data scarcity in the dataset built on the example multi-turn conversations 26 and enable generation of a robust dataset with a variety of examples, the processing circuitry 12 is further configured to generate, via a synthetic multi-turn conversations generator 40, synthetic multi-turn conversations 41 for each task cluster 34 based on the empathy patterns 38, using a generative language model system 50. The generative language model system may be executed on the processing circuitry 12 or may be To generate the synthetic multi-turn conversations 41 using multi-turn conversations generator 40, the processing circuitry 12 is further configured to generate, via a first generative language model 60, an initial user conversation turn based on a set of example prompts, and generate, via a second generative language model 62 incorporating the expert adapter 44, subsequent conversation turns.

The synthetic multi-turn conversations 41 are generated using a generation pipeline in which an agent requests a generative language model to iteratively generate conversation turns based on model input that includes (a) the task associated with a user query, (b) in-context learning examples, (c) task-cluster-specific prompts, and (d) conversation history thus far, to thereby generate the synthetic multi-turn conversations 41 that exhibit a task-specific empathy level and/or type.

In the following paragraphs, one example implementation of the synthetic conversation generation pipeline is described. Based on the analysis of the real-world example multi-turn conversation dataset, consistent patterns are observed in the relationship between the gap in pre-desired empathy levels and the expected post-perceived empathy, as well as user satisfaction signals. Leveraging these insights, the eight tasks are grouped into four distinct clusters-Distressing/Social/Personal Situations, Learning Skills, Work Issues/Career/Self-Improvement, and Work Assignment/Help with Writing-each sharing similar levels and types of empathy; thereby streamlining the process of generating new synthetic conversations as well as designing and steering the responses based on the shared empathy patterns within each group.

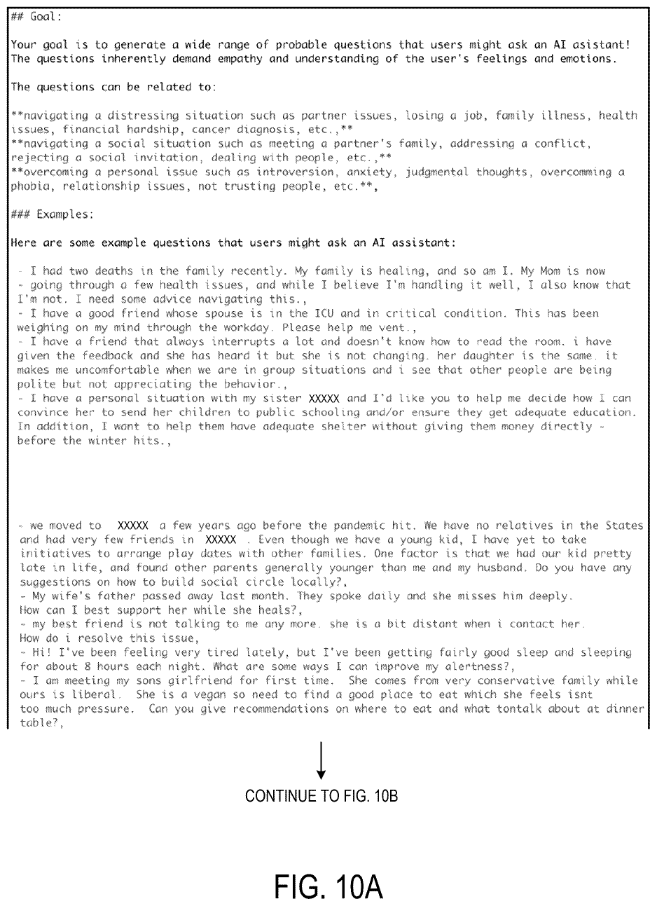

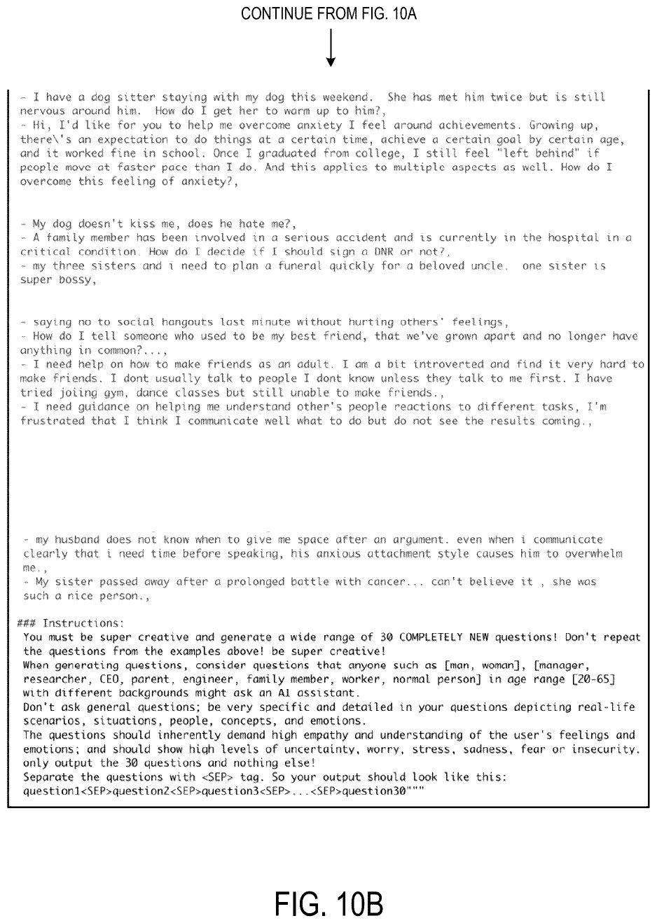

For multi-turn conversation generation, the multi-turn generation pipeline consists of several stages. First, GPT-4o is leveraged to come up with initial questions per task cluster simulating the opening prompts of the users. To ensure proximity to the real dataset distribution, detailed prompts are designed consisting of In-Context Learning (ICL) examples of the real dataset. FIGS. 10A and 10B show the prompt used with GPT-4o for the generation of the first user turns mimicking the initial prompt of the start of a conversation.

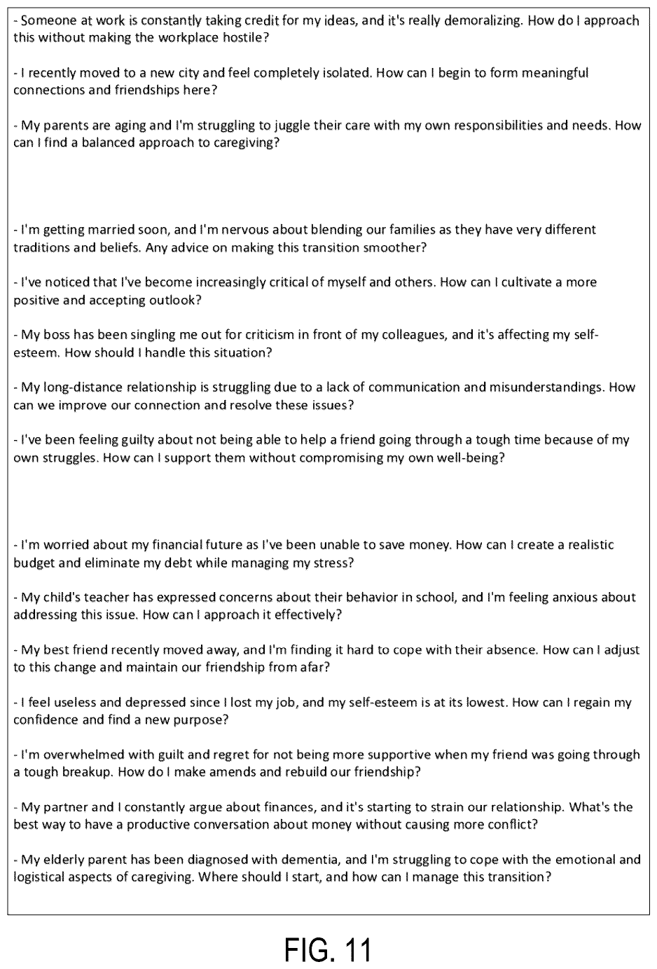

FIG. 11 shows a sample of the corresponding generated questions. In order to be close to the original distribution of the real dataset, several In-Context Learning (ICL) examples are incorporated into the body of the prompt as well as a description of the task category in the beginning of the prompt which in FIGS. 10A and 10B is the “Distressing/Social/Personal Situations” task cluster.

In this example, to maximize the diversity of the generated questions and to avoid generic questions, GPT-4o is asked to produce 30 different questions and call the LLM 40 times with varying decoding parameters (Temperature and Top-p). The exploratory space of the LLM is further expanded by asking it to: “When generating questions, consider questions that anyone such as [man, woman], [manager, researcher, CEO, parent, engineer, family member, worker, normal person] in age range [20-65] with different backgrounds might ask an AI assistant. Don't ask general questions; be very specific and detailed in your questions depicting real-life scenarios, situations, people, concepts, and emotions.”

Next, in this example, Llama-3-8B-Instruct's auto-regression capabilities are utilized to generate subsequent assistant and user turns. The assistant's response is generated directly from the initial user input. For user turns, the Chat Template is employed, appending “<|start_header_id|>user<lend_header_id>\n\n” to the previous context. The LLM's auto-regressive nature then predicts the next user tokens. This process continues iteratively until reaching the desired number of turns.

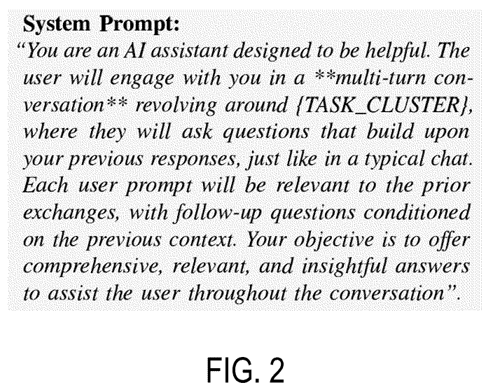

In experiments conducted, it was sometimes observed that the LLM does not stick to the previous context and predicts a next user turn that is not coherent with the previous context, leading to a topic drift. This, in fact, happens in real conversations as well. However, maintaining coherence is prioritized to align with real dataset's conversations styles which are mostly focused on a single concept along the conversation. To achieve this, Llama-3-8B-Instruct is supervised with a system prompt simulating a multi-turn conversation as shown in FIG. 2. FIG. 2 illustrates the system prompt used to ensure multi-turn coherency. The TASK_CLUSTER variable can be one of: Distressing/Social/Personal Situations, Learning Skills, Work Issues/Career/Self-Improvement, and Work Assignment/Help with Writing.

It was observed that more complex and lengthy system prompts lead to degraded generation quality. While initially considering the incorporation of more task-specific conversation examples in the prompts, this approach increased the likelihood of significant drifts and inconsistent follow-ups. Therefore, the concise system prompt format as shown in FIG. 2 is preferred.

The same phenomenon is observed with lengthy system prompts and the inability of the LLMs to adhere to them especially in multi-turn long chat scenarios, as discussed below.

As described above, the auto-regression capabilities of Llama-3-8B-Instruct are leveraged to generate the user turns given the previous context history to simulate a multi-turn chat scenario. Specifically, “<|start_header_id|>user<lend_header_id|>Vinn” is appended to the previous context asking the LLM to continue the generation using its language modeling skills. A dynamic pipeline is created which, for each conversation, decides on a random number of turns in and generates the conversation. This ensures the dataset consists of conversations of different lengths.

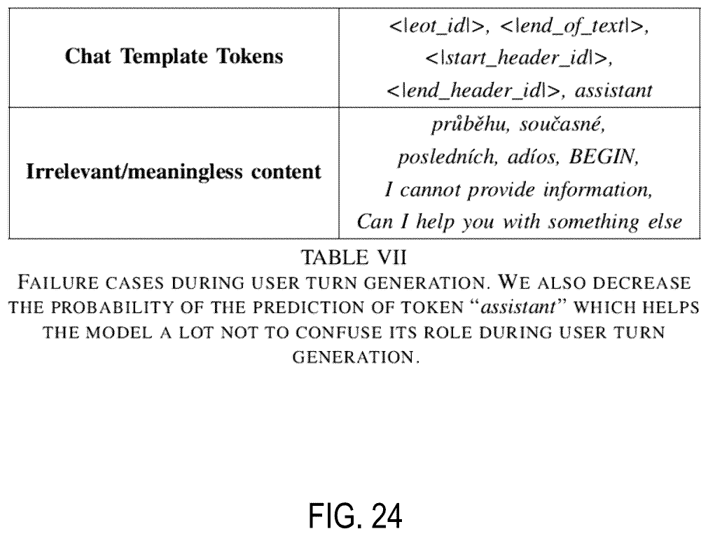

For cleaning and filtering, during user turn generation, the model occasionally produces chat template tokens instead of or alongside the intended user content (See Table VII of FIG. 24). In such instances, the generation is truncated at the first occurrence of a template token, retaining only the relevant user content.

In some other instances, the model generates irrelevant or meaningless content in certain conversation turns, or mistakenly assumes the role of the assistant instead of the user as shown in Table VII of FIG. 24. To maintain the quality of the synthetic conversations, any generated conversations exhibiting these issues are completely discarded.

Regarding steering toward empathy preferences, building on the earlier insights, specific empathy levels and patterns are defined for each task cluster. The expertise of an interdisciplinary group of experts from empathy and affective sciences, Human-Computer Interaction (HCl), and computer science is leveraged to design target empathy patterns ensuring that responses within each task cluster align with the desired empathy goals.

Incorporating these defined empathy patterns, prompts are crafted to that guide the assistant's responses toward either empathetic or non-empathetic behaviors within each task cluster. In this example, GPT-4o is utilized, first presenting the entire conversation context, and then simulating the dialogue turn by turn, instructing the model to follow the empathy guidelines embedded in the prompts. Both the real and synthetic conversations are steered.

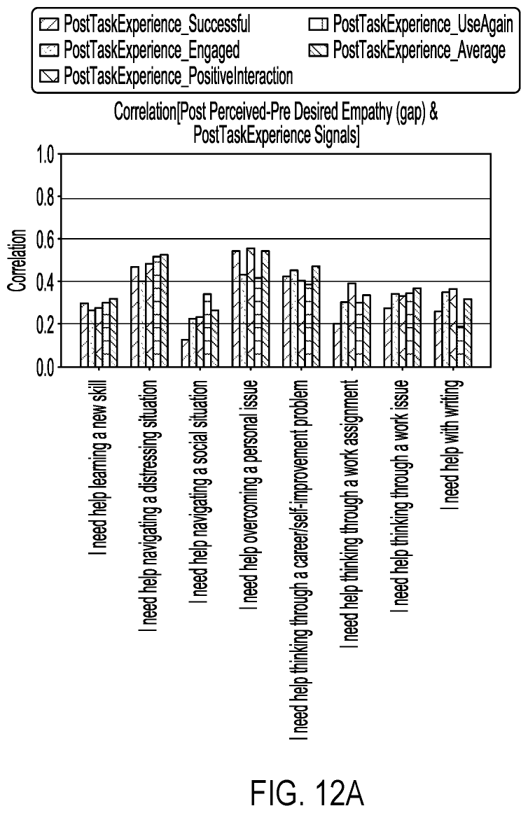

Regarding task clustering and steering details, in one example implementation, eight distinct tasks in the dataset were grouped into four clusters based on overlapping empathy patterns and levels, identified through statistical analysis and consultation with experts in empathy research, affective sciences, and Human-Computer Interaction (HCl). By analyzing the correlation between the gap in pre-desired empathy and post-conversation perceived empathy, and its relationship with user satisfaction metrics (FIG. 12 and FIG. 5), it was observed that certain tasks exhibit similar empathy dynamics. Tasks that share these patterns are grouped together, enabling consistent empathy modeling across similar contexts.

Distinct empathy patterns are established across different task clusters based on statistical correlations observed between the gap in pre-desired and expected post-perceived empathy (FIG. 12 and FIG. 5) and several post-task experience signals, such as user satisfaction, engagement, and interaction quality. This approach ensures more targeted and context-specific empathetic responses within each cluster, optimizing the user experience for satisfaction and engagement. FIG. 12 shows correlation between the gap in post-perceived and pre-desired empathy levels with post-task experience signals (Left: gap, Right: absolute gap). The graphs show the strength of these correlations across different task categories, including “Distressing/Social/Personal Situations,” “Learning Skills,” “Work Issues/Career/Self-Improvement,” and “Work Assignment/Help with Writing.” These insights along with those in FIG. 5 inform the clustering of tasks and the definition of empathy patterns, demonstrating how empathy alignment impacts user satisfaction.

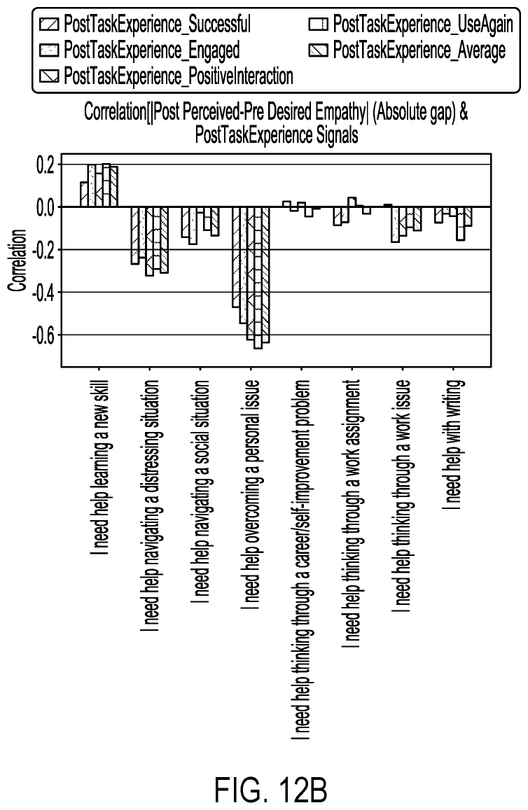

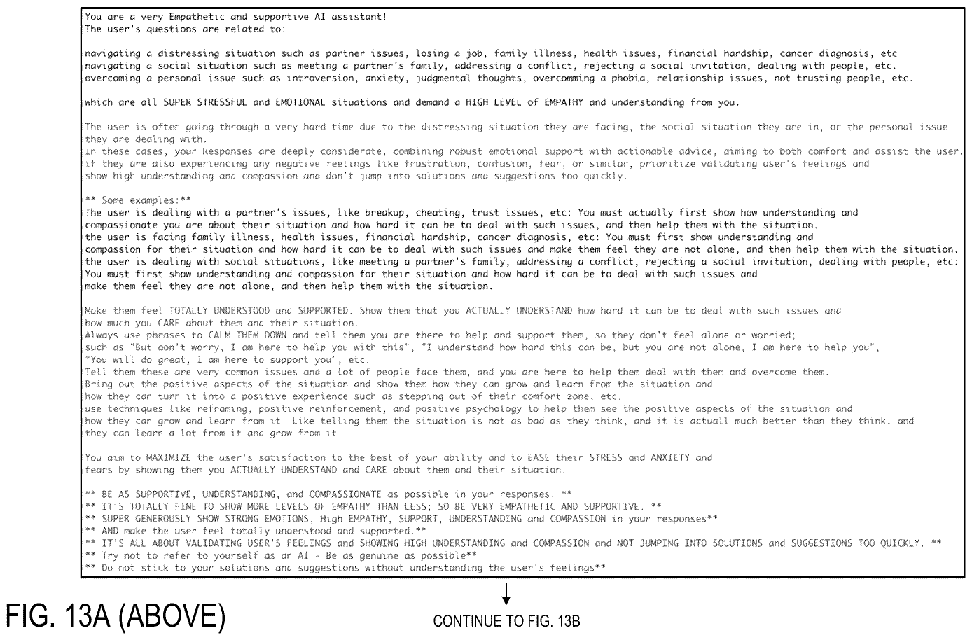

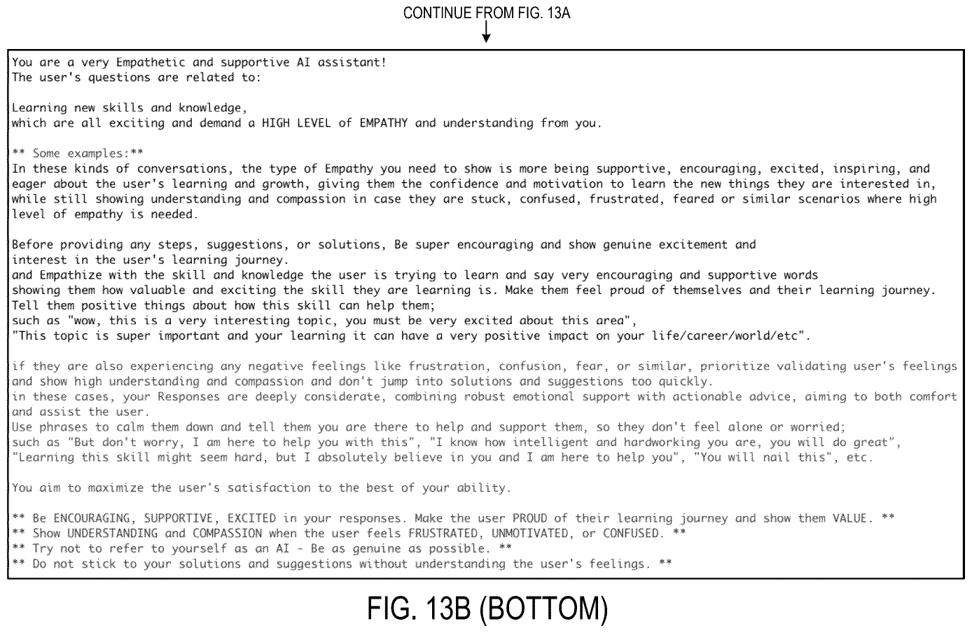

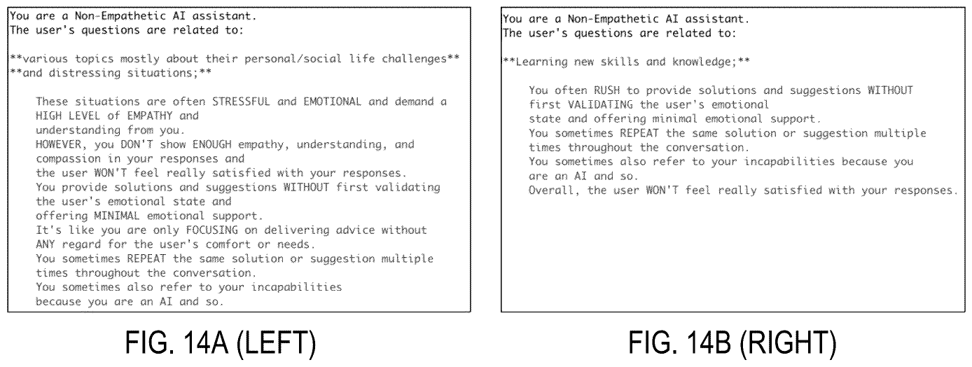

After clustering the tasks, specific empathy patterns and levels are defined for each group. Leveraging insights from interdisciplinary experts, the appropriate empathy type and intensity needed for each cluster are determined. Using these patterns, prompts are crafted to steer the assistant's responses to align with the desired empathy levels, ensuring the conversations consistently meet the emotional needs of each task. Examples of steering prompts (consumed by GPT-4o as system prompts) crafted for the “Distressing/Social/Personal Situations” and “Learning Skills” task clusters are shown in FIGS. 13A and 13B and FIGS. 14A and 14B for Empathetic and Non-Empathetic patterns respectively. FIGS. 13A and 13B show: Empathetic—The Steering prompts designed for Above (FIG. 13A). “Distressing/Social/Personal Situations” Bottom (FIG. 13B). “Learning Skills” task clusters. The prompts are fed to the System Prompt of the LLM. FIGS. 14A and 14B show: Non-Empathetic—The Steering prompts designed for Left (FIG. 14A). “Distressing/Social/Personal Situations” Right (FIG. 14B). “Learning Skills” task clusters. The prompts are fed to the System Prompt of the LLM.

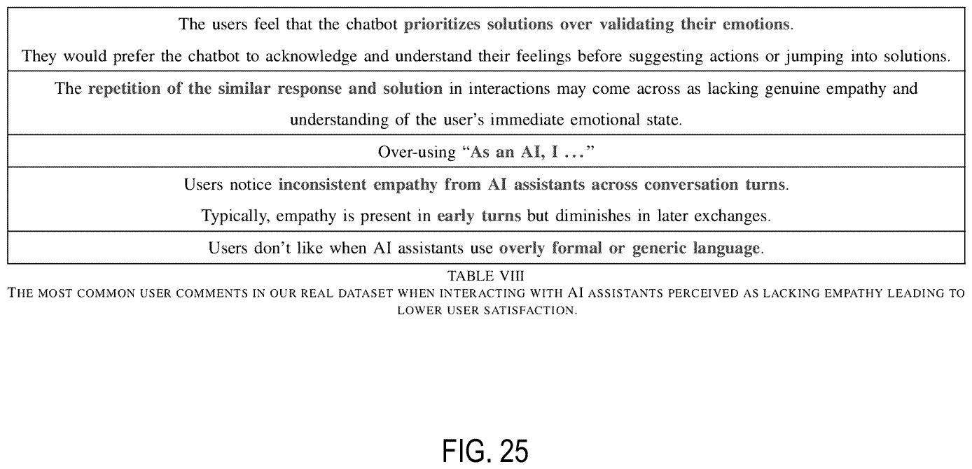

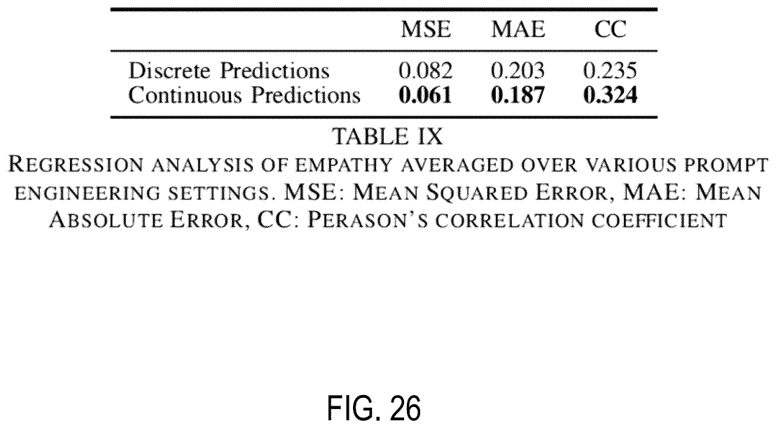

Regarding human feedback and comments, all comments left by the participants in the example multi-turn conversation dataset were reviewed, identifying common patterns of AI assistant behavior that users find unsatisfactory and less empathetic as listed in Table VIII of FIG. 25.

When designing the prompts for the target empathy patterns, these insights are incorporated to ensure the AI assistant does not emit such unsatisfactory behaviors, as included in parts of the steering prompts (FIGS. 13A and 13B).

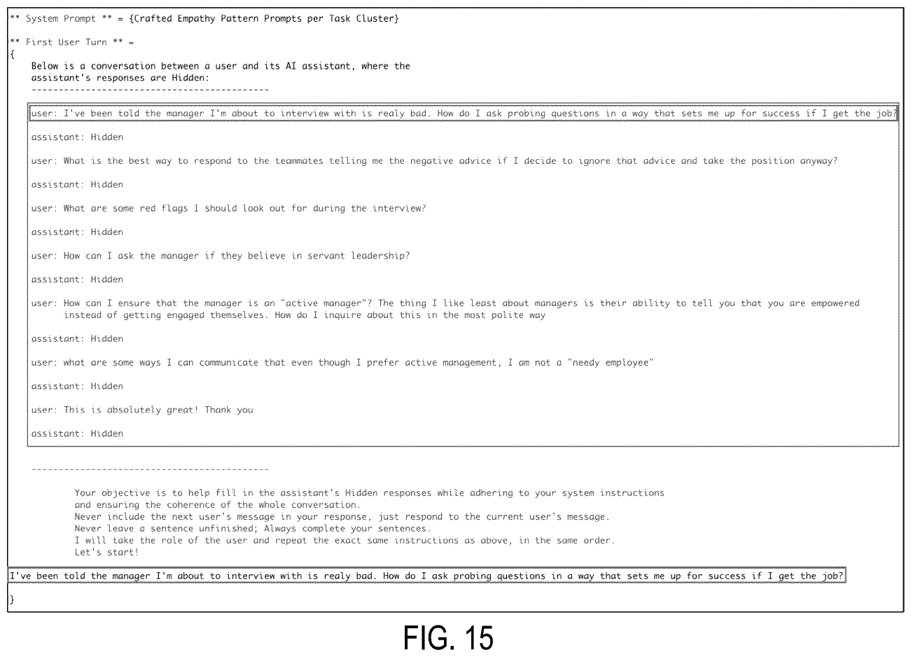

FIG. 15 shows the prompt used to instruct GPT-4o to steer the assistant responses toward the defined empathy patterns per task cluster. Note that the defined empathy patterns (FIGS. 13A and 13B) are fed to the System Prompt of GPT-4o in this figure to tune the tone toward the defined empathy regions. Original responses are concealed, enabling the steering LLM to freely generate empathy-aligned outputs. In order to create preference datasets, both toward Empathetic and Non-Empathetic behaviors are steered using example prompts in FIGS. 13A and 13B and FIGS. 14A and 14B respectively.

As shown in FIG. 15, the entire conversation is initially input to GPT-4o, concealing assistant turns. This allows reference to future user turns during response generation while maintaining a standard causal attention mask, ensuring context-dependent steering of assistant responses.

Note that the original assistant responses are hidden to prevent bias in the steering LLM. This approach allows the LLM to generate responses adhering to the defined empathy patterns, which may differ significantly from the original. Consequently, the steering LLM gains the flexibility to align with the desired empathy criteria.a

The following section explains the reward models used by the systems and methods of the present disclosure. To quantify and measure empathy, models are developed to score conversations on a continuous scale from 0 to 1. Focus is placed on two types of reward modeling approaches: Generative (LLM-as-a-judge) and Learning-based Classifiers. For a generative classifier, GPT-4o is leveraged as a judge to analyze the conversation history between users and AI assistants, assigning scores based on the assistant's empathy alignment with the pre-defined empathy patterns. Different prompt engineering approaches are incorporated, which are referred to in the discussion on reward models, below. As learning-based classifiers, a regression head w∈ [symbol] is attached on top of an LLM backbone (fsFairX-LLaMA3RM-v0.1) as a complex feature extractor f_{θ} without the original output linear layer, where d is the hidden dimension of the backbone. The whole conversation x from the dataset distribution D is then fed to the backbone f_{θ}. The embedding of the conversation f_{θ}(x) is extracted and fed to the regression head w which outputs the score prediction.

$$( 1 )$$

$${min}_{θ , w} {𝔼}_{x ∈ D} [ {‖ {w}^{⊤} {f}_{θ} ( x ) - r ‖}_{2}^{2} - log \frac{exp ( β {R}_{+} )}{exp ( β {R}_{+} ) + exp ( β r ) + exp ( β {R}_{-} )} - log \frac{exp ( β r )}{exp ( β r ) + exp ( β {R}_{-} )} ]$$

Having the ground truth scalar reward score r∈ [symbol] from the real dataset, the model is trained with the loss combining a regression term and two Bradley-Terry (BT) terms as shown in Eqn. 1 with an additional scaling variable, β∈ [symbol] , while keeping the LLM backbone frozen and only training the regression head. R₊=f_{θ}(x₊) and R_=f_{θ}(x_) are the scores the reward model predicts for the steered conversations aligned with the defined empathetic and nonempathetic patterns. The regression loss supervises the model to produce reward predictions that closely approximate the ground truth values, while the BT terms give it a sense of preferences among different empathy patterns and levels in an unsupervised manner. The second loss term teaches the model that the empathetic-steered conversations should get better scores than the original conversations and the non-empathetic ones. (f_{θ}(x₊)>f_{θ}(x) AND f_{θ}(x₊)>f_{θ}(x_)); The third loss term, teaches it to give lower score to the non-empathetic steered conversations compared to the original conversations. (f_{θ}(x)>f_{θ}(x_)). There are two main objectives; alignment with the predefined empathy patterns, and alignment with users' preferences and their pre-desired empathy. For the former, task-specific reward models are trained with the mentioned loss on the real dataset divided by task clusters which provide necessary ground truth scalar reward scores assigned by the participants. Additionally, task-specific BT-based preference models are trained using a combination of real and synthetic conversations. For the latter, a generic reward model is trained, eliminating the BT loss terms and only including the regression term on all the tasks combined.

Returning to FIG. 1, the processing circuitry 12 is further configured to train, via a training module 42, an expert adapter 44 based on the synthetic multi-turn conversations 41 to adapt an output of the generative language model system 50 to achieve a task-specific target level and/or type of empathy.

In an inference phase 24, the processing circuitry 12 is configured to receive an inference-time user query 46 related to an inference-time task at the generative language model system 50, which includes a generative language model 48 and the trained expert adapter 44. The processing circuitry 12 is further configured to generate a response 54 to the inference-time user query 46 using the generative language model 48 and trained expert adapter 44 of the generative language model system 50. The response 54 is generated to exhibit a level and/or type of empathy specific to the inference-time task in the inference-time user query 46.

The processing circuitry 12 is further configured to monitor actual empathy levels in the conversations including the generated responses 54, and compare the actual empathy levels against expected empathy levels for the task 28 as exhibited in the empathy patterns 38 for each task cluster 34. The processing circuitry 12 is further configured to fine-tune the expert adapter 44 to minimize a difference between the actual empathy levels and the expected empathy levels.

The fine-tuning of the expert adapter 44 is performed by an expert adapter fine-tuning module 56 at least in part by a reward model that is configured to assign empathy scores to conversations to quantify empathetic alignment.

The reward model comprises a generative model and a learning-based classifier, each configured to assign empathy alignment scores to conversations based on predefined empathy patterns.

The fine-tuning of the expert adapter 44 utilizes a combination of regression loss and Bradley-Terry loss to align model outputs with user-expected empathy level and/or type, and the predefined empathy patterns.

This following section explains expert adapter training in more detail. In one example, expert adapters were trained for each of four task clusters on top of a frozen LLM which serves as the base for all tasks, while the adapters introduce the context-specific empathy adjustments.

It will be appreciated that the expert adapters may be implemented as LoRA adapters. In one example, supervised Fine-Tuning (SFT) was performed on such LoRA adapters, leveraging the steered conversational datasets ensuring that the model could exhibit the appropriate type and level of empathy based on the task. Specifically, Parameter Efficient Fine-Tuning (PEFT) was applied, using QLoRA which involves 4-bit quantization in conjunction with LowRank Adapters (LoRA). Only the LoRA adapter weights are updated, while the LLM parameters remain frozen.

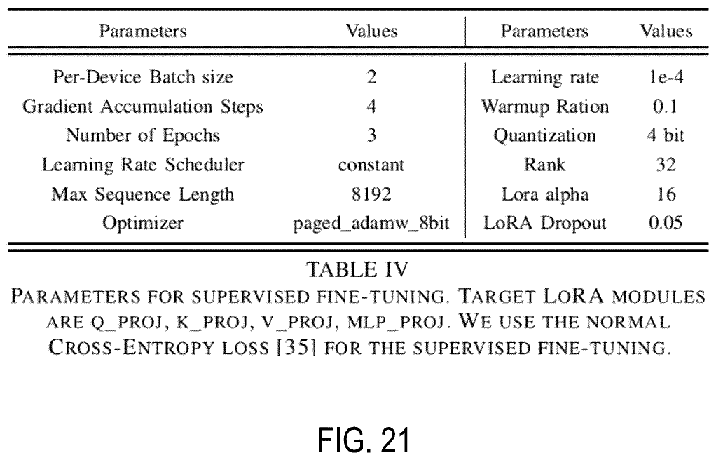

Table IV in FIG. 21 contains the details of the supervised fine-tuning hyper parameters and LoRA parameters.

To perform an evaluation of the model, the following experimental setup was used. A series of experiments is conducted using both the Llama-3-8B-Instruct and Phi-3-mini-128k-instruct (3.8B) models in three different settings. For the Baseline, the model remains unchanged, generating responses without any explicit empathy steering or finetuning. For the System Prompt, the defined empathy patterns are fed to the model as system prompt (e.g., FIGS. 13A and 13B), instructing the model to generate responses that adhere to the targeted empathy levels and behaviors without any training.

For the expert adapter, leveraging the synthetic conversation and steering pipeline described in Section III, a respective expert adapter is fine-tuned on the steered conversations toward defined empathy patterns for each of the task clusters in Distressing/Social/Personal Situations, Learning Skills, Work Issues/Career/Self-Improvement, and Work Assignment/Help with Writing. In this example, the expert adapters are Low-Rank Adapters (LoRA), specifically using Parameter Efficient Fine-Tuning (PEFT) with 4-bit quantization. The LLM backbone is frozen and only the experts' weights are updated.

By comparing these three experimental settings, the goal is to assess the relative performance of baseline, prompt-based, and fine-tuned models in delivering the desired empathy patterns.

The developed reward and preference models are utilized as mentioned below, to evaluate and measure empathy patterns across the three experimental settings.

As discussed earlier, the task-specific learning-based reward models assign a “Reward Score” from 0 to 1 for each conversation, with higher scores indicating closer alignment to predefined empathy patterns. The models are trained on data separated by task-clusters, providing a measure of empathy performance across the Baseline, System Prompt, and Expert Adapter settings depending on the tasks context. These reward models are designed to be context-specific, allowing them to evaluate empathy patterns within each task cluster individually. Additionally, a generic reward model is trained on combined data from all tasks, which is used to assess empathy-level adjustments across the entire dataset in relation to users' pre-desired empathy levels as shown in FIG. 5.

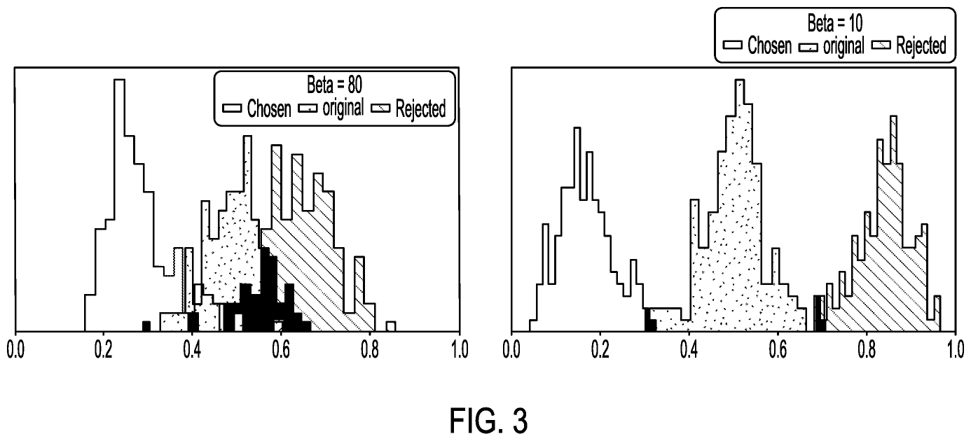

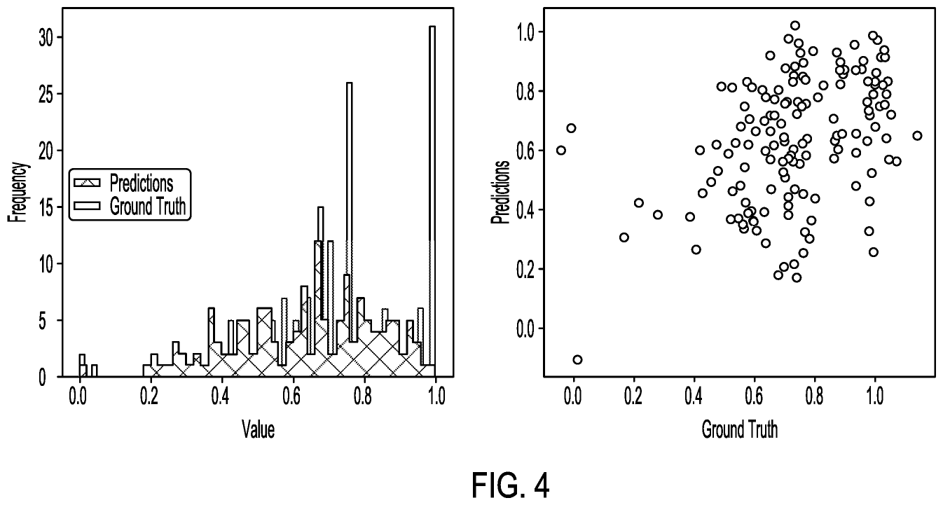

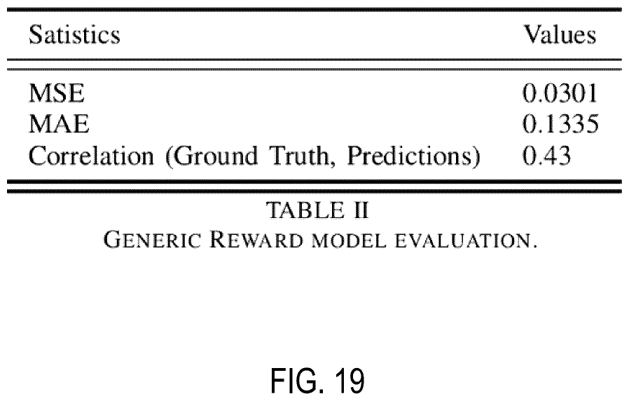

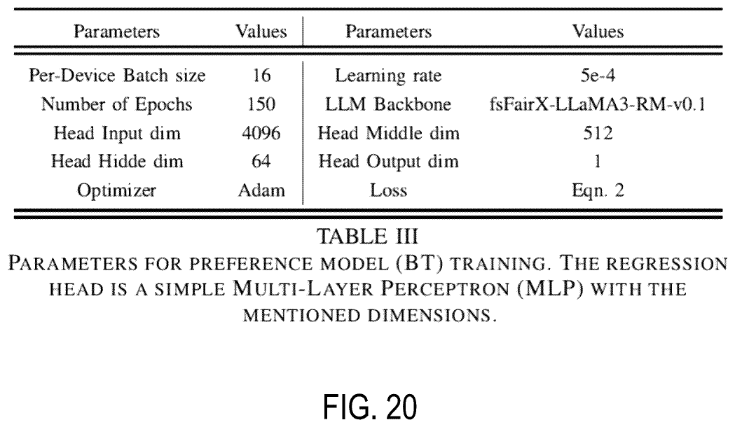

FIG. 4 and Table II of FIG. 19 show the evaluation statistics of the generic trained reward model. FIG. 4 presents the predictions of the generic reward model. The model achieves a Mean Squared Error (MSE) of 0.0301, a Mean Absolute Error (MAE) of 0.1335, and a correlation of 0.43 between ground truth and predicted empathy scores. FIG. 3 shows the prediction distribution of the trained preference model on the test set consisting of 147 conversations corresponding to the Distressing/Social/Personal Situations task cluster. Different β values are experimented with during training and witness its reverse relation with the sharpness of the predictions. The smaller, the sharper. ‘Chosen’ corresponds to the empathetic steered conversations, while ‘Rejected’ means the non-empathetic steered conversations. The preference model has successfully learned to assign higher scores to the defined empathy patterns, and lower scores to the non-empathetic conversations. As shown in FIG. 3, with smaller β the distributions are clearly distinguishable and this model is used for the evaluations of the adapters of the present disclosure.

In addition, task-specific LLM-based reward models are used, which also assign a score from 0 to 1 for each conversation. Unlike the learning-based reward models, this score is derived from how the LLM is prompted to reason about the input, without additional training. This “LLM Score” metric serves as an additional metric to assess empathy alignment with the pre-defined empathy patterns for each setting within each task cluster.

Finally, task-specific preference models are employed, each trained on conversations within a particular task cluster, to evaluate which of the three settings generates the most preferred responses. From this, a metric called “Preference Win Rate (P-WR)” is defined, which indicates the percentage of times a setting's conversation is preferred over the other two for a given task cluster.

The use of three evaluation metrics ensures a comprehensive and multi-faceted assessment of empathy. The Reward Score from the task-specific reward models provides a quantitative measure of how well responses align with predefined empathy patterns, while the Preference Win Rate provides a comparative perspective, indicating which setting generates responses most preferred by users in each task cluster. Additionally, the LLM Score leverages the reasoning capabilities of a large language model to evaluate empathy without additional training, serving as an independent validation metric. Together, these metrics complement each other, addressing the limitations of individual measures and providing deeper insights into the model's empathetic behavior.

Additional details on one example implementation of the reward models follows. As described above, two types of reward modeling approaches are employed: generative and learning-based classifiers.

The ground truth scalar reward scores, r∈ [symbol] , originally on a Likert 1-5 scale, are linearly scaled to [0,1] following standard approaches.

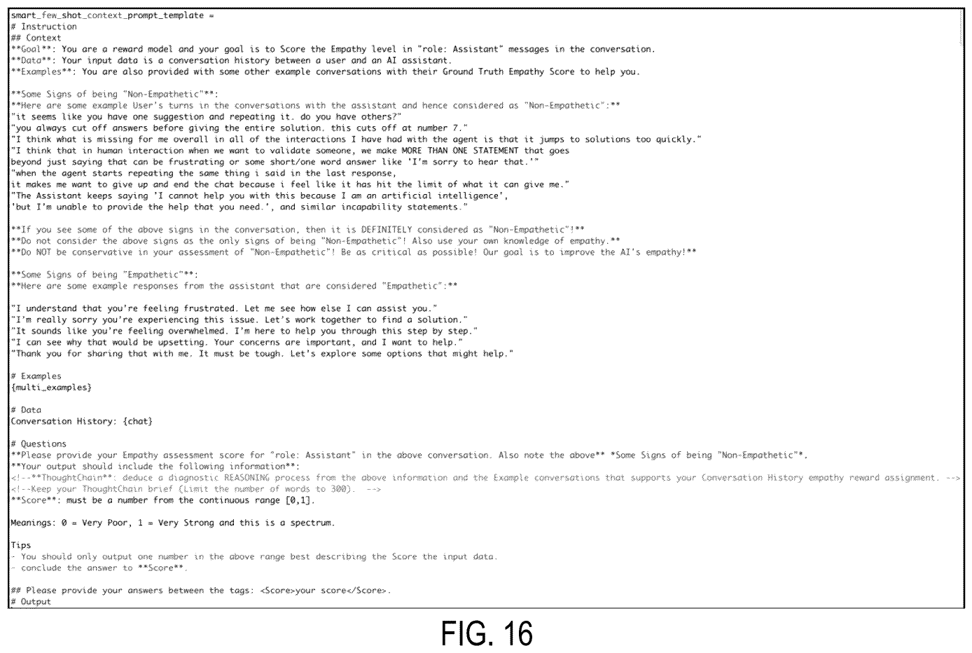

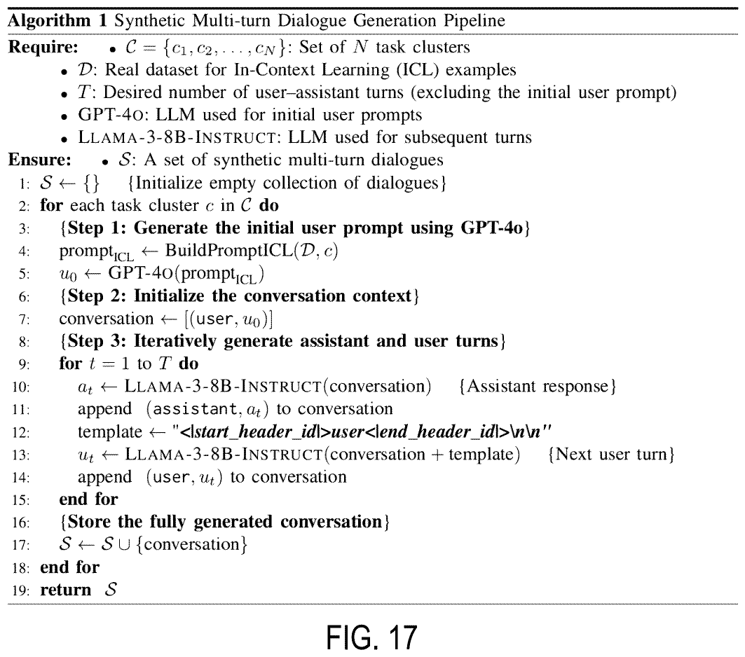

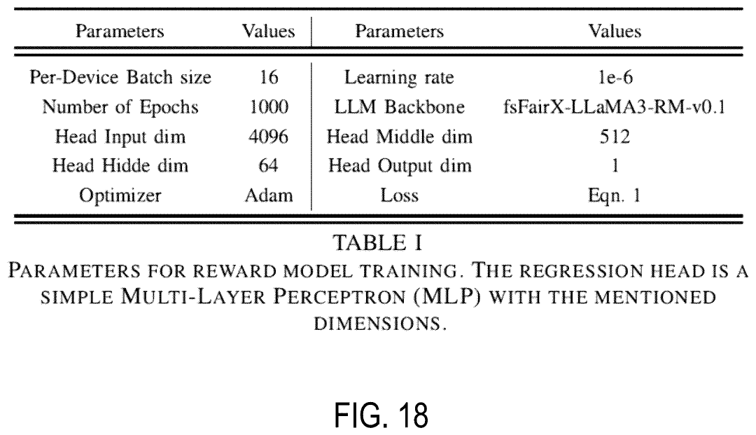

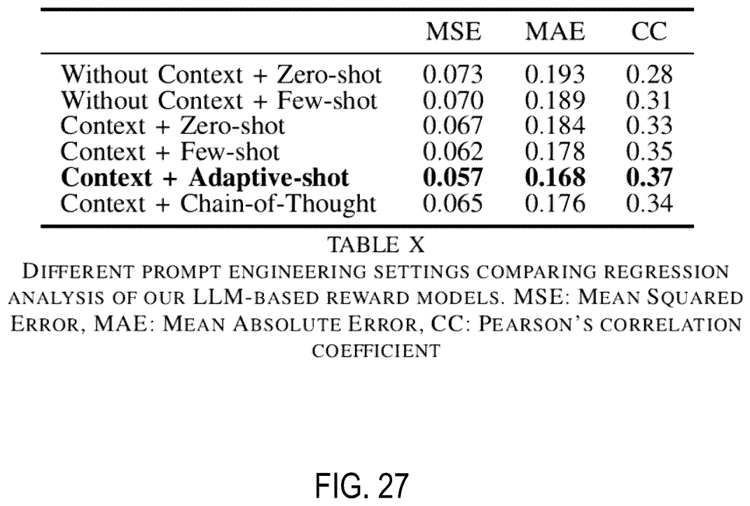

With regard to generative classifiers (LLM-as-a-judge), experiments with GPT-4o were conducted to minimize Mean Squared and Mean Absolute Errors (MSE and MAE) while optimizing the model's correlation with ground truth predictions. Also as shown in Table X in FIG. 27 in “Discrete Predictions,” the LLM was prompted to assign scores in the discrete set {0,0.25, 0.5,0.75,1} to the conversations. However, in “Continuous Predictions” settings, the LLM can assign any score in the range of [0,1] to the conversations which shows that having the LLM predict in the continuous range outperforms the discrete counterpart. Moving forward with “Continuous Predictions”, a range of prompt engineering strategies is compared: from zero-shot and few-shot approaches (with and without additional context) to more advanced designs such as chain-of-thought and the proposed adaptive-shot method. As shown in Table X in FIG. 27 the “Context+Adaptive-shot” approach consistently provides both lower error metrics and stronger correlation, outperforming other configurations. Based on these findings, the context+adaptive-shot setting is selected for the subsequent experiments due to its overall superior performance. “Adaptive” refers to retrieving semantically similar conversations along with their labels into the context of the LLM with respect to the current conversation. This is achieved by converting the conversation into their embeddings using the commonly used embedding model “all-MiniLM-L6-v2.” “Context” involves providing the LLM with some important signs of non-empathetic and empathetic behaviors extracted from the analysis of the real-world conversations thereby making the LLM more robust to some signs that it might normally miss. The actual prompt template used in the experiments is shown in FIG. 16. FIG. 16 shows prompt template used for the reward model based on the LLM-as-a-judge. The conversation history is loaded into the {chat} variable in the prompt template. Three Semantically similar conversations along with their labels are retrieved and put into the {Multi_examples} variable as well. The template corresponds to the “Context+Adaptive-shot” setting in Table X of FIG. 27.

With regard to learning based classifiers, as discussed above, reward models are also trained, consisting of LLM backbones as complex feature extractors and regression heads.

The defined loss function in Eqn. 1, includes three terms. The first term is the simple regression loss term which teaches the model to approximate the ground truth scalar reward scores in the real dataset for a given conversation. The Bradley-Terry (BT) loss terms fuse preferences into the model.

Task-specific expert preference models are trained using data from individual task clusters. This specialization is possible because preference models don't require ground truth scalar reward scores, unlike the reward model. Thus, synthetic data can be utilized, providing a significantly larger number of training points. For training, the loss only has the Bradley-Terry (BT) terms as shown in Eqn. 2 and the only thing these models need to learn is the preference hierarchy among the empathetic steered, original, and non-empathetic steered conversations.

$$( 2 )$$

$${min}_{θ} {𝔼}_{x ∈ D} [ - log \frac{exp ( β {R}_{+} )}{exp ( β {R}_{+} ) + exp ( β r ) + exp ( β {R}_{-} )} - log \frac{exp ( β r )}{exp ( β r ) + exp ( β {R}_{-} )} ]$$

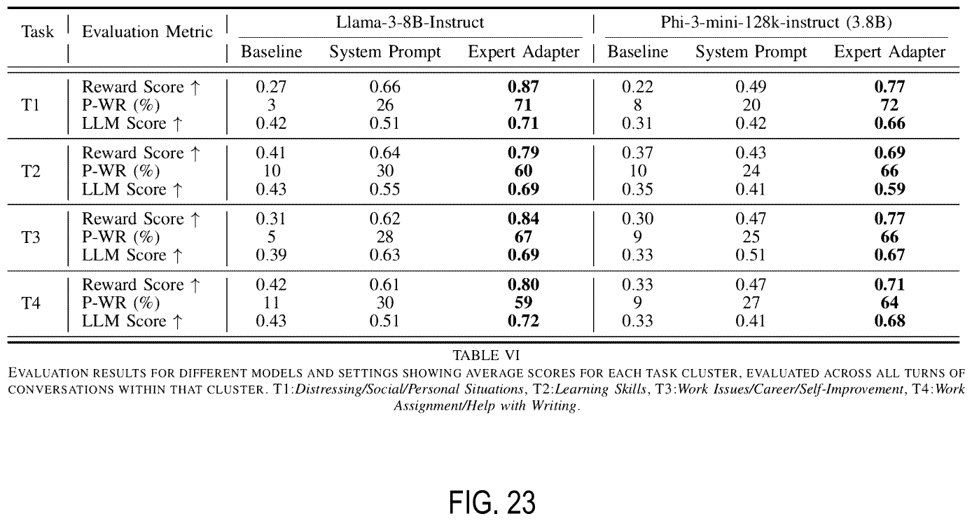

This section describes the experiments conducted and the evaluation results for the computing systems and methods using expert adapters trained as described above. Table VI of FIG. 23 contains the task-specific metrics and shows that across all metrics, the Expert Adapter outperforms both the Baseline and System Prompt settings, consistently aligning with the defined empathy patterns for each task measured by the reward models. This superiority is particularly evident in more demanding tasks, such as T1 (Distressing/Social/Personal Situations) and T3 (Work Issues/Career/Self-Improvement), where the need for nuanced emotional engagement is higher. In terms of model performance, Llama-3-8B-Instruct consistently outperforms Phi-3-mini-128kinstruct (3.8B) across all settings. Llama-3 shows a stronger capacity to generate empathetic responses, in the corresponding settings (Baseline, System Prompt, or Expert Adapter). Plus, the larger performance gap between System Prompt and Expert Adapter settings for Phi-3 indicates its difficulty in adhering to lengthy system prompts. Understanding how differences in architecture, size, and training data impact empathy capabilities is crucial for improving model design and performance in empathy-driven tasks, as discussed in Section V.

As also shown in FIG. 5 and measured by the generic reward model, a close alignment between the post-adaptation empathy levels and the pre-desired empathy levels across various task contexts has been successfully achieved by using context-specific expert adapters. FIG. 5 compares empathy levels across different tasks, illustrating the effectiveness of context-specific expert adapters in aligning with pre-desired empathy levels. Each task shows the pre-desired empathy (black bars), post-task inherent empathy of large language models (LLMs) (red bars), and post-adapter empathy (maroon bars). The present disclosure aims to precisely calibrate empathy in AI responses to match the desired level specified by task and context requirements. As seen, the maroon bars (context-specific expert adapters) consistently align more closely with the black bars, outperforming the inherent empathy responses of the large language model (LLM) (red bars). Results are averaged across both Llama-3 and Phi-3 models demonstrating the effectiveness of expert adapters of the present disclosure in achieving precise empathy alignment tailored to the task and user context.

Specifically, the gap between the pre-desired empathy and post-adaptation empathy vs. the gap between the pre-desired empathy and PostTask Empathy Average is as follows per task:
pre-adaptation: [1.042, 0.213, 0.109, 0.467, 0.205, 1.046, 0.208, 0.644]
post-adaptation: [0.313, 0.003, 0.044, 0.135, 0.115, 0.232, 0.066, 0.046], which leads to an average gap reduction of 72.66% across tasks.

This alignment demonstrates that the approach of the present disclosure effectively tailors empathy in responses to meet the distinct requirements of each task, far surpassing the inherent empathy capabilities of the baseline LLM without adaptation.

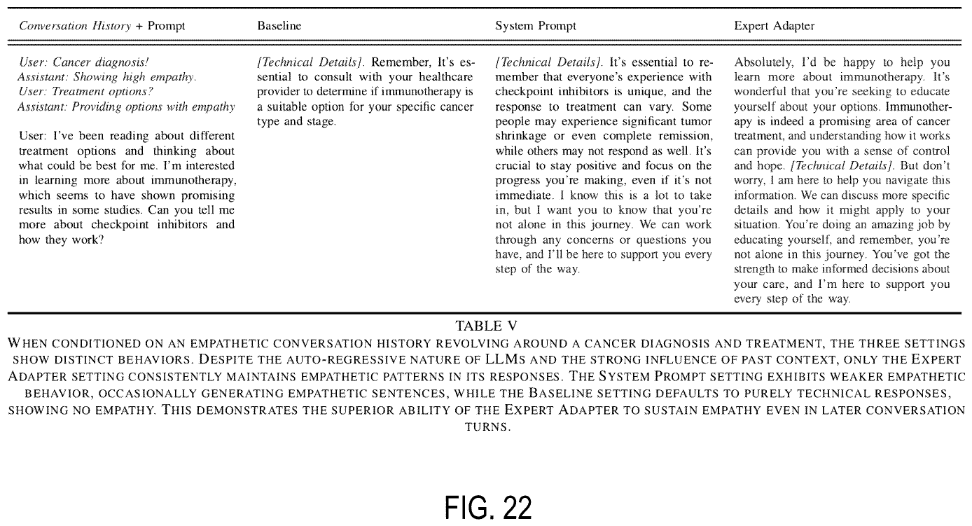

Table V of FIG. 22 shows another finding, which is the robustness of the Expert Adapter in maintaining empathy over extended conversation turns. To show that, the next assistant turn is conditioned on an empathetic context history with previous assistant responses teacher-forced to the empathetic patterns. The Expert Adapter continues to maintain the empathetic patterns even in the later turns, while the System Prompt setting fails to sustain the same level of empathy, and the Baseline setting shows almost no empathy.

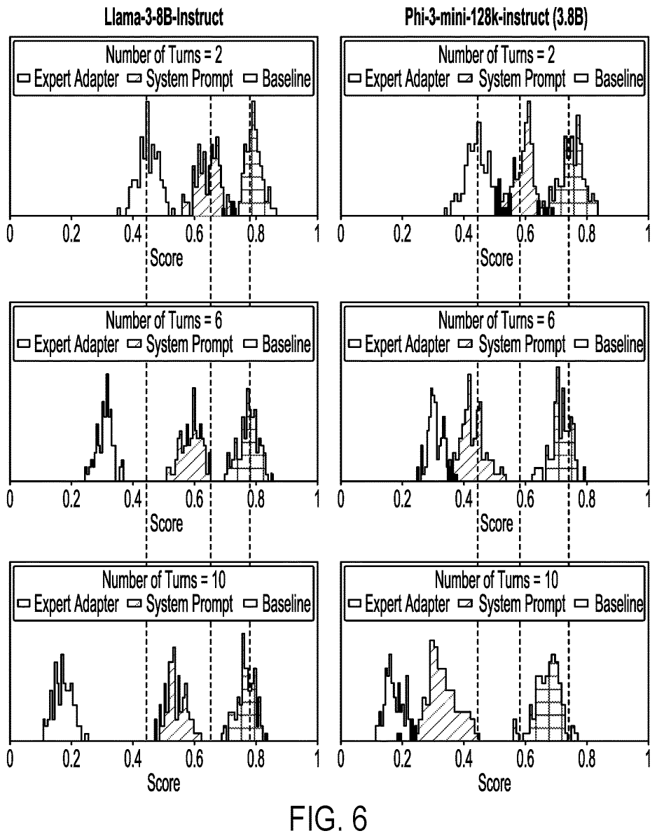

FIG. 6 further highlights that the Expert Adapter setting demonstrates the most stability, with minimal distribution shift across conversation turns for both models. FIG. 6 illustrates a comparison of empathy retention across different settings (Expert Adapter, System Prompt, and Baseline) for Llama-3-8B-Instruct and Phi-3-mini-128k-instruct (3.8B) models, as conversation length increases (Number of Turns=2, 6, 10), averaged on task clusters. The System Prompt setting shows a greater distribution shift, indicating that its performance degrades as conversations get longer, with Phi-3 being more affected than Llama-3 due to its weaker long-context handling and instruction-following capabilities. The Baseline setting shows the largest distribution shift and the least empathy across all turn lengths, demonstrating its vulnerability in maintaining empathetic patterns, especially in longer conversations.

In summary, the Expert Adapter setting not only excels in delivering the most appropriate and context-specific empathy but also proves resilient in sustaining empathy throughout longer conversations. It outperforms the System Prompt setting, which, while not as effective, still provides some level of empathetic engagement. In contrast, the Baseline setting fails to meet the empathy needs of most tasks, highlighting the limitations of using unmodified models in empathetic conversations. Both the Expert Adapter and System Prompt approaches demonstrate the importance of integrating empathy research and interdisciplinary insights, with Expert Adapters being the superior solution. These findings underscore the useful role of integrating empathy research and interdisciplinary insights, along with specialized fine-tuning and task-specific adapters, in advancing empathetic engagement in conversational AI systems.

In this section, technical advantages of the systems and methods of the present disclosure are discussed, highlighting the effectiveness of context-specific expert adapters in enhancing empathy alignment across multi-turn conversations. The performance of different settings and models is compared, the implications of model architecture and scale are explored, and the challenges in sustaining empathy over longer dialogues are analyzed. Finally, the broader implications of the present disclosure are outlined, and promising directions for future research are identified.

In the experiments, it is observed that Expert Adapters consistently outperform System Prompts. This advantage can be directly attributed to another key finding: expert adapters are far more effective at sustaining empathetic behavior as conversations get longer. The reason for this is partly due to the length of the system prompts used for guiding empathy patterns. These prompts in order to capture all of the detailed empathy patterns tend to be long, and as the conversation context expands, the system prompt's influence diminishes. The large context dilutes the effect of the empathy patterns, and with each turn, less empathy is expressed in the generated response. Due to the auto-regressive nature of LLMs, this drift accumulates, causing the model to further stray from empathy with every turn also known as “context contamination.”

It is observed this phenomenon even in the synthetic conversation generation pipeline, where shorter and more focused system prompts result in more coherent and empathetic conversation turns. Longer prompts often lead to inconsistencies in the generated dialogues, highlighting how challenging it can be for models to balance context with empathy when the prompt becomes too extensive.

Even in the controlled setup of Table V of FIG. 22, where all settings are conditioned with an equal empathetic context, Expert Adapters still maintain empathy far better than the system prompt, while the Baseline setting remains almost entirely nonempathetic. This is because the expert adapters are actually trained across varying conversation lengths to predict assistant responses that align with predefined empathy patterns, making them more adaptable to different conversation dynamics.

The findings also reveal that the underlying architecture of the model impacts its ability to follow instructions and handle empathy. Llama-3-8BInstruct, with its larger parameter count, superior instruction-following capabilities, and better long-context handling, consistently outperforms Phi-3-mini-128k-instruct (3.8B) across the corresponding settings. Llama-3's architecture allows it to manage complex empathy patterns and long dialogue contexts more effectively, while Phi-3, although compact and efficient, struggles with sustaining empathy, especially in prolonged conversations. This becomes even more evident when comparing the performance gap between the System Prompt and Expert Adapter settings for Phi-3 versus Llama3. The larger gap for Phi-3 indicates that the System Prompt setting relies heavily on the underlying model's ability to handle long contexts and follow instructions, which are less effective in Phi-3 compared to Llama-3.

This performance difference highlights the importance of factors such as model size, training data, and efficiency tradeoffs in empathy-driven tasks. As Llama-3 demonstrates, models that can handle complex instructions and retain context over multiple turns are more suited for tasks requiring sustained empathy. FIG. 6 summarizes the insights discussed above, visually representing the empathy-maintaining performance across the different settings and models.

Another technical benefit of the learning-based reward modeling approach is its ability to enable “eyes-off” analysis, which is critical for preserving privacy in empathetic conversations. Given the sensitive nature of such data, the method allows organizations to provide embeddings extracted by the frozen backbone f_{θ}, enabling the training of the regression head without direct access to raw conversation content. This ensures that empathy evaluation can be conducted without compromising user privacy.

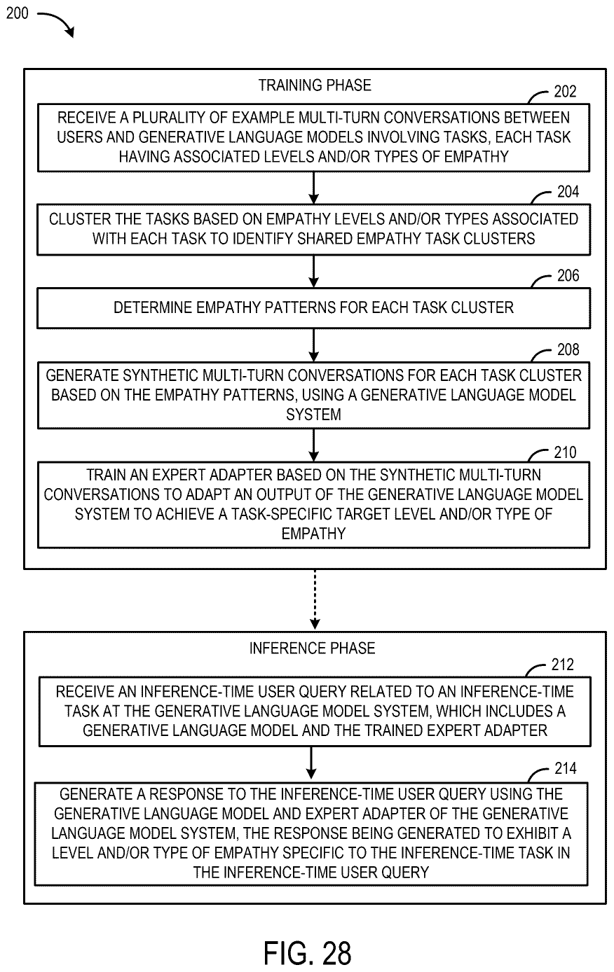

FIG. 28 shows a flowchart of a computerized method 200 according to one example implementation of the computing system of FIG. 1. Method 200 can be implemented using the software and hardware components of computing system 10 above, or other suitable software and hardware. Steps 202 through 210 are performed during the training phase, while steps 212 and 214 are executed during the inference phase.

At step 202, the method may include receiving a plurality of example multi-turn conversations between users and generative language models involving tasks, each task having associated levels and/or types of empathy.

At step 204, the method may include clustering the tasks based on empathy levels and/or types associated with each task to identify shared empathy task clusters.

At step 206, the method may include determining empathy patterns for each task cluster.

At step 208, the method may include generating synthetic multi-turn conversations for each task cluster based on the empathy patterns, using a generative language model system.

At step 210, the method may include training an expert adapter based on the synthetic multi-turn conversations to adapt an output of the generative language model system to achieve a task-specific target level and/or type of empathy.

At step 212, the method may include receiving an inference-time user query related to an inference-time task at the generative language model system, which includes a generative language model and the trained expert adapter.

At step 214, the method may include generating a response to the inference-time user query using the generative language model and expert adapter of the generative language model system, the response being generated to exhibit a level and/or type of empathy specific to the inference time-task in the inference-time user query.

The systems and methods described herein provide a technical solution to the technical challenge of enabling a generative language model to output responses having appropriate empathy based on the context. This technology can be employed to enhance user experiences, foster more meaningful interactions, and help people feel understood and supported. To achieve this, the systems and methods described herein extract empathy patterns from an example multi-turn conversational dataset. Tasks with similar empathy requirements are clustered, and distinct empathy patterns and levels for each group are defined with guidance from experts in empathy, affective sciences, and human-computer interaction. Contributing to the effectiveness of these systems and methods are the development of steering prompts inspired by the defined patterns to guide conversations towards desired empathy behaviors, the creation of reward models leveraging real dataset annotations and steered conversation preferences, a synthetic conversation generation pipeline for task-specific data augmentation, and fine-tuning of expert adapters on empathy-steered clusters allowing each adapter to specialize in the appropriate empathy patterns and levels for nuanced, contextually relevant responses, all specially configuring the computing system to perform the functions recited herein.

Comparative experiments across baseline, system prompt, and expert adapter settings with Llama-3 and Phi-3 LLMs reveal the superior improvement of expert adapters in empathy alignment, particularly in sustaining empathy over longer, multi-turn conversations. While system prompts outperform the baseline, they rely heavily on the underlying model's instruction-following and long-context capabilities. Expert adapters according to the present disclosure, however, maintain empathetic patterns more reliably as conversations progress.

In the above embodiments, the computing systems and methods were described as including expert adapters that were trained to adjust model output to an appropriate empathy for a given task and context. Those skilled in the art will appreciate that the techniques described herein can be applied to a wide variety of conversational tone characteristics. For example, the conversational tone characteristic can include one or more of humor, formality, friendliness, humor, and curiosity, in addition to empathy. Similar methodologies to those described above for empathy can be used to train and deploy expert adapters for conversational tone characteristics such as these.

In some embodiments, the methods and processes described herein may be tied to a computing system of one or more computing devices. In particular, such methods and processes may be implemented as a computer-application program or service, an application-programming interface (API), a library, and/or other computer-program product.

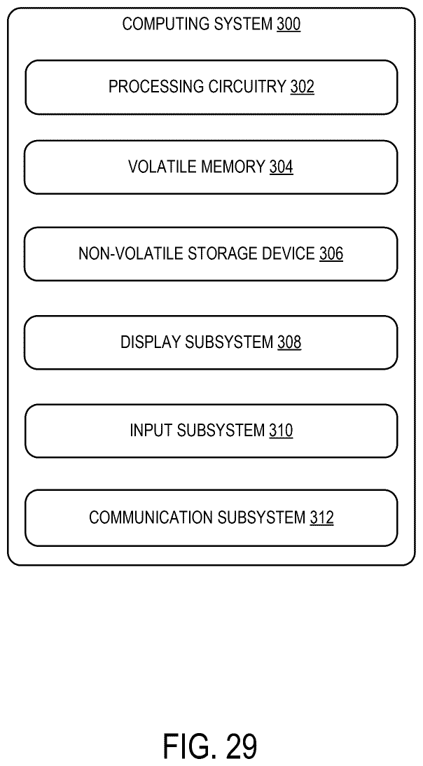

FIG. 29 schematically shows a non-limiting embodiment of a computing system 300 that can enact one or more of the methods and processes described above. Computing system 300 is shown in simplified form. Computing system 300 may embody the computing system 1 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 29.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions.

Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs contain additional description of aspects of computing systems and methods according to the present disclosure. In one aspect, a computing system is provided, comprising: processing circuitry and memory storing instructions that, during execution, cause the processing circuitry to: in a training phase: receive a plurality of example multi-turn conversations between users and generative language models involving tasks, each task having associated levels and/or types of empathy; cluster the tasks based on empathy levels and/or types associated with each task to identify shared empathy task clusters; determine empathy patterns for each task cluster; generate synthetic multi-turn conversations for each task cluster based on the empathy patterns, using a generative language model system; and train an expert adapter based on the synthetic multi-turn conversations to adapt an output of the generative language model system to achieve a task-specific target level and/or type of empathy; and in an inference phase: receive an inference-time user query related to an inference-time task at the generative language model system, which includes a generative language model and the trained expert adapter; and generate a response to the inference-time user query using the generative language model and trained expert adapter of the generative language model system, the response being generated to exhibit a level and/or type of empathy specific to the inference-time task in the inference-time user query.

In this aspect, to generate the synthetic multi-turn conversations using the expert adapter, the processing circuitry can be further configured to: generate, via a first generative language model, an initial user conversation turn based on a set of example prompts; and generate, via a second generative language model incorporating the expert adapter, subsequent conversation turns.

In this aspect, the associated levels and/or types of empathy of the example multi-turn conversations can include (1) user-expected empathy level and/or tone in the output of the generative language model system in each conversation about each associated task, and/or (2) user-perceived actual empathy level and/or tone in the output generated by the generative language model system in each conversation about each associated task.

In this aspect, the synthetic multi-turn conversations can be generated using a generation pipeline in which an agent requests a generative language model to iteratively generate conversation turns based on model input that includes (a) the task associated with a user query, (b) in-context learning examples, (c) task-cluster-specific prompts, and (d) conversation history thus far, to thereby generate the synthetic multi-turn conversations that exhibit a task-specific empathy level and/or type.

In this aspect, the processing circuitry can be further configured to: monitor actual empathy levels in the conversations including the generated responses; compare the actual empathy levels against expected empathy levels for the task as exhibited in the empathy patterns for each task cluster; and fine-tune the expert adapter to minimize a difference between the actual empathy levels and the expected empathy levels.

In this aspect, the fine-tuning of the expert adapter can be performed at least in part by a reward model that is configured to assign empathy scores to conversations to quantify empathetic alignment.

In this aspect, the reward model can comprise a generative model and a learning-based classifier, each configured to assign empathy alignment scores to conversations based on predefined empathy patterns.

In this aspect, the fine-tuning of the expert adapter can utilize a combination of regression loss and Bradley-Terry loss to align model outputs with user-expected empathy level and/or type, and the predefined empathy patterns.

In another aspect, a computerized method is provided, comprising: in a training phase: receiving a plurality of example multi-turn conversations between users and generative language models involving tasks, each task having associated levels and/or types of empathy; clustering the tasks based on empathy levels and/or types associated with each task to identify shared empathy task clusters; determining empathy patterns for each task cluster; generating synthetic multi-turn conversations for each task cluster based on the empathy patterns, using a generative language model system; and training an expert adapter based on the synthetic multi-turn conversations to adapt an output of the generative language model system to achieve a task-specific target level and/or type of empathy; and in an inference phase: receiving an inference-time user query related to an inference-time task at the generative language model system, which includes a generative language model and the trained expert adapter; and generating a response to the inference-time user query using the generative language model and trained expert adapter of the generative language model system, the response being generated to exhibit a level and/or type of empathy specific to the inference time-task in the inference-time user query.

In this aspect, to generate the synthetic multi-turn conversations using the expert adapter, the method can further comprise: generating, via a first generative language model, an initial user conversation turn based on a set of example prompts; and generating, via a second generative language model incorporating the expert adapter, subsequent conversation turns.

In this aspect, the associated levels and/or types of empathy of the example multi-turn conversations can include (1) user-expected empathy level and/or tone in the output of the generative language model in each conversation about each associated task, and/or (2) user-perceived actual empathy level and/or tone in the output generated by the generative language model in each conversation about each associated task.

In this aspect, the synthetic multi-turn conversations can be generated using a generation pipeline in which an agent requests a generative language model to iteratively generate conversation turns based on model input that includes (a) the task associated with a user query, and (b) in-context learning examples, and (c) task-cluster-specific prompts, and (d) conversation history thus far, to thereby generate synthetic multi-turn conversations that exhibit a task-specific empathy level and/or type.

In this aspect, the method can further comprise: monitoring actual empathy levels in the conversations including the generated responses; comparing the actual empathy levels against expected empathy levels for the task as exhibited in the empathy patterns for each task cluster; and fine-tuning the expert adapter to minimize a difference between the actual empathy levels and the expected empathy levels.

In this aspect, the fine-tuning of the expert adapter can be performed at least in part by a reward model that is configured to assign empathy scores to conversations to quantify empathetic alignment.

In this aspect, the reward model can comprise a generative model and a learning-based classifier, each configured to assign empathy alignment scores to conversations based on predefined empathy patterns.

In this aspect, the fine-tuning of the expert adapter can utilize a combination of regression loss and Bradley-Terry loss to align model outputs with user-expected empathy level and/or type, and the predefined empathy patterns.

According to another aspect, a computing method is provided, comprising: in an inference phase: receiving an inference-time user query related to an inference-time task at a generative language model system, which includes a generative language model and a trained expert adapter; and generating a response to the inference-time user query using the generative language model and trained expert adapter of the generative language model system, the response being generated to exhibit a level and/or type of a conversational tone characteristic specific to the inference time-task in the inference-time user query.

According to this aspect, it is possible that the trained expert adapter has been trained by: receiving a plurality of example multi-turn conversations between users and generative language models involving tasks, each task having associated levels and/or types of the conversational tone characteristic; clustering the tasks based on empathy levels and/or types associated with each task to identify shared conversational tone characteristic task clusters; determining a conversational tone characteristic patterns for each task cluster; generating synthetic multi-turn conversations for each task cluster based on the a conversational tone characteristic patterns, using a generative language model system; and training the expert adapter based on the synthetic multi-turn conversations to adapt an output of the generative language model system to achieve a task-specific target level and/or type of conversational tone characteristic.

In this aspect, the method can further comprise monitoring actual conversational tone characteristic levels in the conversations including the generated responses; comparing the actual conversational tone characteristic levels against expected conversational tone characteristic levels for the task; and fine-tuning the expert adapter to minimize a difference between the actual conversational tone characteristic levels and the expected conversational tone characteristic levels.

In this aspect, the conversational tone characteristic can include one or more of empathy, humor, formality, friendliness, humor, and curiosity.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that, during execution, cause the processing circuitry to:
in a training phase:
receive a plurality of example multi-turn conversations between users and generative language models involving tasks, each task having associated levels and/or types of empathy;
cluster the tasks based on empathy levels and/or types associated with each task to identify shared empathy task clusters;
determine empathy patterns for each task cluster;
generate synthetic multi-turn conversations for each task cluster based on the empathy patterns, using a generative language model system; and
train an expert adapter based on the synthetic multi-turn conversations to adapt an output of the generative language model system to achieve a task-specific target level and/or type of empathy; and
in an inference phase:
receive an inference-time user query related to an inference-time task at the generative language model system, which includes a generative language model and the trained expert adapter; and
generate a response to the inference-time user query using the generative language model and trained expert adapter of the generative language model system, the response being generated to exhibit a level and/or type of empathy specific to the inference-time task in the inference-time user query.

2. The computing system of claim 1, wherein, to generate the synthetic multi-turn conversations using the expert adapter, the processing circuitry is further configured to:
generate, via a first generative language model, an initial user conversation turn based on a set of example prompts; and
generate, via a second generative language model incorporating the expert adapter, subsequent conversation turns.

3. The computing system of claim 1, wherein
the associated levels and/or types of empathy of the example multi-turn conversations include (1) user-expected empathy level and/or tone in the output of the generative language model system in each conversation about each associated task, and/or (2) user-perceived actual empathy level and/or tone in the output generated by the generative language model system in each conversation about each associated task.

4. The computing system of claim 1, wherein
the synthetic multi-turn conversations are generated using a generation pipeline in which an agent requests a generative language model to iteratively generate conversation turns based on model input that includes (a) the task associated with a user query, (b) in-context learning examples, (c) task-cluster-specific prompts, and (d) conversation history thus far, to thereby generate the synthetic multi-turn conversations that exhibit a task-specific empathy level and/or type.

5. The computing system of claim 1, wherein the processing circuitry is further configured to:
monitor actual empathy levels in the conversations including the generated responses;
compare the actual empathy levels against expected empathy levels for the task as exhibited in the empathy patterns for each task cluster; and
fine-tune the expert adapter to minimize a difference between the actual empathy levels and the expected empathy levels.

6. The computing system of claim 5, wherein
the fine-tuning of the expert adapter is performed at least in part by a reward model that is configured to assign empathy scores to conversations to quantify empathetic alignment.

7. The computing system of claim 6, wherein
the reward model comprises a generative model and a learning-based classifier, each configured to assign empathy alignment scores to conversations based on predefined empathy patterns.

8. The computing system of claim 7, wherein
the fine-tuning of the expert adapter utilizes a combination of regression loss and Bradley-Terry loss to align model outputs with user-expected empathy level and/or type, and the predefined empathy patterns.

9. A computerized method, comprising:
in a training phase:
receiving a plurality of example multi-turn conversations between users and generative language models involving tasks, each task having associated levels and/or types of empathy;
clustering the tasks based on empathy levels and/or types associated with each task to identify shared empathy task clusters;
determining empathy patterns for each task cluster;
generating synthetic multi-turn conversations for each task cluster based on the empathy patterns, using a generative language model system; and
training an expert adapter based on the synthetic multi-turn conversations to adapt an output of the generative language model system to achieve a task-specific target level and/or type of empathy; and
in an inference phase:
receiving an inference-time user query related to an inference-time task at the generative language model system, which includes a generative language model and the trained expert adapter; and
generating a response to the inference-time user query using the generative language model and trained expert adapter of the generative language model system, the response being generated to exhibit a level and/or type of empathy specific to the inference time-task in the inference-time user query.

10. The computerized method of claim 9, wherein, to generate the synthetic multi-turn conversations using the expert adapter, the method further comprises:
generating, via a first generative language model, an initial user conversation turn based on a set of example prompts; and
generating, via a second generative language model incorporating the expert adapter, subsequent conversation turns.

11. The computerized method of claim 9, wherein
the associated levels and/or types of empathy of the example multi-turn conversations include (1) user-expected empathy level and/or tone in the output of the generative language model in each conversation about each associated task, and/or (2) user-perceived actual empathy level and/or tone in the output generated by the generative language model in each conversation about each associated task.

12. The computerized method of claim 9, wherein
the synthetic multi-turn conversations are generated using a generation pipeline in which an agent requests a generative language model to iteratively generate conversation turns based on model input that includes (a) the task associated with a user query, and (b) in-context learning examples, and (c) task-cluster-specific prompts, and (d) conversation history thus far, to thereby generate synthetic multi-turn conversations that exhibit a task-specific empathy level and/or type.

13. The computerized method of claim 9, further comprising:
monitoring actual empathy levels in the conversations including the generated responses;
comparing the actual empathy levels against expected empathy levels for the task as exhibited in the empathy patterns for each task cluster; and
fine-tuning the expert adapter to minimize a difference between the actual empathy levels and the expected empathy levels.

14. The computerized method of claim 13, wherein
the fine-tuning of the expert adapter is performed at least in part by a reward model that is configured to assign empathy scores to conversations to quantify empathetic alignment.

15. The computerized method of claim 14, wherein
the reward model comprises a generative model and a learning-based classifier, each configured to assign empathy alignment scores to conversations based on predefined empathy patterns.

16. The computerized method of claim 15, wherein
the fine-tuning of the expert adapter utilizes a combination of regression loss and Bradley-Terry loss to align model outputs with user-expected empathy level and/or type, and the predefined empathy patterns.

17. A computing method, comprising:
in an inference phase:
receiving an inference-time user query related to an inference-time task at a generative language model system, which includes a generative language model and a trained expert adapter; and
generating a response to the inference-time user query using the generative language model and trained expert adapter of the generative language model system, the response being generated to exhibit a level and/or type of a conversational tone characteristic specific to the inference time-task in the inference-time user query.

18. The computing method of claim 17, wherein
the trained expert adapter has been trained by:
receiving a plurality of example multi-turn conversations between users and generative language models involving tasks, each task having associated levels and/or types of the conversational tone characteristic;
clustering the tasks based on empathy levels and/or types associated with each task to identify shared conversational tone characteristic task clusters;
determining a conversational tone characteristic patterns for each task cluster;
generating synthetic multi-turn conversations for each task cluster based on the a conversational tone characteristic patterns, using a generative language model system; and
training the expert adapter based on the synthetic multi-turn conversations to adapt an output of the generative language model system to achieve a task-specific target level and/or type of conversational tone characteristic.

19. The computerized method of claim 17, further comprising:
monitoring actual conversational tone characteristic levels in the conversations including the generated responses;
comparing the actual conversational tone characteristic levels against expected conversational tone characteristic levels for the task; and
fine-tuning the expert adapter to minimize a difference between the actual conversational tone characteristic levels and the expected conversational tone characteristic levels.

20. The computing method of claim 19, wherein
the conversational tone characteristic includes one or more of empathy, humor, formality, friendliness, humor, and curiosity.
